(19) United States
(12) Patent Application Publication
(10) Pub. No.: US 2015/0062295 A1
(43) Pub. Date: Mar. 5, 2015

(54) IMAGE PROCESSING SYSTEM, TRANSMITTING DEVICE, RECEIVING DEVICE, TRANSMITTING METHOD, RECEIVING METHOD, AND COMPUTER PROGRAM

(71) Applicants: Aki Yoneda, Hyogo (JP); Kazuhiro Mochinaga, Hyogo (JP); Hiroshi Yahata, Osaka (JP); Toru Kawaguchi, Tokyo (JP); Yuka Ozawa, Osaka (JP)

(72) Inventors: Aki Yoneda, Hyogo (JP); Kazuhiro Mochinaga, Hyogo (JP); Hiroshi Yahata, Osaka (JP); Toru Kawaguchi, Tokyo (JP); Yuka Ozawa, Osaka (JP)

(21) Appl. No.: 14/239,559

(22) PCT Filed: Aug. 24, 2012
(86) PCT No.: PCT/JP2012/005306

§ 371 Date: Feb. 19, 2014

Related U.S. Application Data
(60) Provisional application No. 61/527,858, filed on Aug. 26, 2011.

(51) Int. Cl. H04N 13/00; H04N 21/2343; H04N 21/4363; H04N 21/81; H04N 21/4385; H04N 21/4402; H04N 19/597; H04N 21/2389

(52) U.S. Cl. CPC H04N 13/0048; H04N 13/0029; H04N 19/597; H04N 21/2343; H04N 21/2389; H04N 21/816; H04N 21/4385; H04N 21/4402; H04N 21/43635
USPC 348/43

(57) ABSTRACT

An image processing system comprising a transmission device and a reception device, wherein the transmission device includes: a 3D encoder encoding 3D images input thereto to generate a 3D program; a stream generator generating a video stream including a plurality of programs, including the 3D program generated by the 3D encoder; a stream transmitter transmitting the video stream; and an information transmitter transmitting information for specifying a priority program within the video stream; and the reception device includes: an information receiver receiving the information; a stream receiver receiving the video stream; and a decoding processor decoding the video stream, specifying the priority program using the information, and performing control such that the priority program is output to a channel used for connecting to a display device at a priority program transfer rate equal to a preceding program transfer rate used for a preceding program output immediately before the priority program.

### TECHNICAL FIELD

The present invention relates to digital broadcasting technology, and in particular to technology for transmitting and receiving a broadcast program in which a 3D program and a 2D program are combined.

### BACKGROUND ART

As the digitisation of television broadcasting progresses, the image quality of broadcast programs is increasing. In recent years, 3D programs have also been broadcast. Currently, 3D programs are encoded in a Side-by-Side format. The Side-by-Side format involves reducing left-view images and right-view images to half-size with respect to the horizontal direction, and combining the images into one to encode the result with the same coding method as a conventional 2D program (e.g., MPEG-2, H.264/MPEG-4AVC, and so on). As such, the Side-by-Side format deteriorates image quality in order to reduce the left-view images and the right-view images.

A coding method in which image quality deterioration is unlikely has been proposed as H.264 Multi View Coding (hereinafter, MVC) (see Non-Patent Literature 1).

In H.264 MVC, for example, the left-view images are encoded using the conventional coding method applied to 2D programs, namely H.264/MPEG-4AVC, while the right-view images are encoded with reference to the left-view images displayed at the same time-stamp. In H.264 MVC, little image quality deterioration is produced in comparison to the Side-by-Side method, and more effective compression results from encoding the right-view images with reference to the left-view images.

Broadcasts combining 2D programs and 3D programs are expected to result from the appearance of this new coding method.

### CITATION LIST

### Non-Patent Literature

[Non-Patent Literature 1]

ISO/IEC 14496-10:2009

### SUMMARY OF INVENTION

### Technical Problem

When 2D programs and 3D programs are combined and the combined programs are broadcast, a reception device must switch between decoding methods with every switch between the 2D programs and the 3D programs. Also, when the reception device is connected to a display device by a High-Definition Multimedia Interface (hereinafter, HDMI) cable, the communication mode used by the HDMI cable must be reset and the transfer rate must be changed with every switch between a 2D program and a 3D program. Resetting the communication mode takes a few seconds, during which the screen of the display device may be blacked out or otherwise unable to normally display the program.

For example, when a 3D program is a main feature while a 2D program is a commercial, switching to the commercial may cause the screen to be blacked out such that the first portion of the commercial cannot be displayed. This is a great problem for broadcast stations, whose revenue is obtained by broadcasting commercials.

As such, in consideration of the above-described problem, the present disclosure aims to provide a image processing system, a transmission device, a reception device, a transmission method, a transmission method, and a computer program enabling a display device to correctly display a program that has priority, despite 2D programs and 3D programs being combined.

### Solution to Problem

In order to achieve the above-stated aim, an image processing system pertaining to an aspect of the disclosure comprises a transmission device and a reception device, wherein the transmission device includes: a 3D encoder encoding 3D images input thereto to generate a 3D program; a stream generator generating a video stream made up of a plurality of programs, including the 3D program generated by the 3D encoder; a stream transmitter transmitting the video stream; and an information transmitter transmitting information for specifying a priority program among the programs in the video stream; and the reception device includes: an information receiver receiving the information; a stream receiver receiving the video stream; and a decoding processor decoding the video stream, specifying the priority program by using the information, and performing control such that the priority program is output to a channel used for connecting to a display device at a priority program transfer rate equal to a preceding program transfer rate used for a preceding program output immediately before the priority program.

### Advantageous Effects of Invention

According to the above-described configuration, the priority program is output at the same transfer rate as the preceding program, thus removing any need for a communication mode reset between the reception device and the display device. Thus, the display device is able to normally display the priority program.

### BRIEF DESCRIPTION OF DRAWINGS

FIG. 1 is a system configuration diagram of an image processing system 1.

FIG. 2 is a block diagram illustrating the configuration of a transmission device 10.

FIGS. 3A and 3B illustrate H.264 and H.264MVC encoding methods.

FIG. 4 illustrates the detailed configuration of a 3D encoder 103.

FIG. 5 illustrates the data configuration of additional information 1400.

FIG. 6 illustrates the data configuration of program information 1500.

FIG. 7 is a flowchart of the operations of the transmission device 10.

FIG. 8 is a block diagram illustrating the configurations of a BD recorder 20 and a digital television 30.

FIG. 9 is a block diagram illustrating the configurations of the BD recorder 20 and the digital television 30.

FIG. 10 is a block diagram illustrating the internal configuration of the decoding processor 204.

FIG. 11 illustrates the concepts of the display mode and the transfer rate.

FIG. 12 is a flowchart of the operations of the BD recorder 20.

FIG. 13 is a flowchart of the operations of the BD recorder 20 and the digital television 30.

FIG. 14 is a block diagram illustrating the configuration of a transmission device 10a.

FIG. 15 is a flowchart of the operations of the transmission device 10a.

FIG. 16 is a block diagram illustrating the configurations of the BD recorder 20a and the digital television 30a.

FIG. 17 is a block diagram illustrating the internal configuration of a decoding processor 204a and an HDMI transmitter 205a.

FIG. 18 is a flowchart of the operations of the BD recorder 20a.

FIG. 19 is a flowchart of the operations of the BD recorder 20a and the digital television 30a.

FIG. 20 is a block diagram illustrating the configuration of a transmission device 10b.

FIG. 21 is a flowchart of the operations of the transmission device 10b.

FIG. 22 is a block diagram illustrating the configurations of a BD recorder 20b and a digital television 30b.

FIG. 23 is a flowchart of the operations of the BD recorder 20b.

FIG. 24 is a system configuration diagram of an image processing system 2.

### DESCRIPTION OF EMBODIMENTS

### 1. Embodiment 1

An image processing system 1 pertaining to Embodiment 1 is described below, with reference to the accompanying drawings.

### <1.1 System Overview>

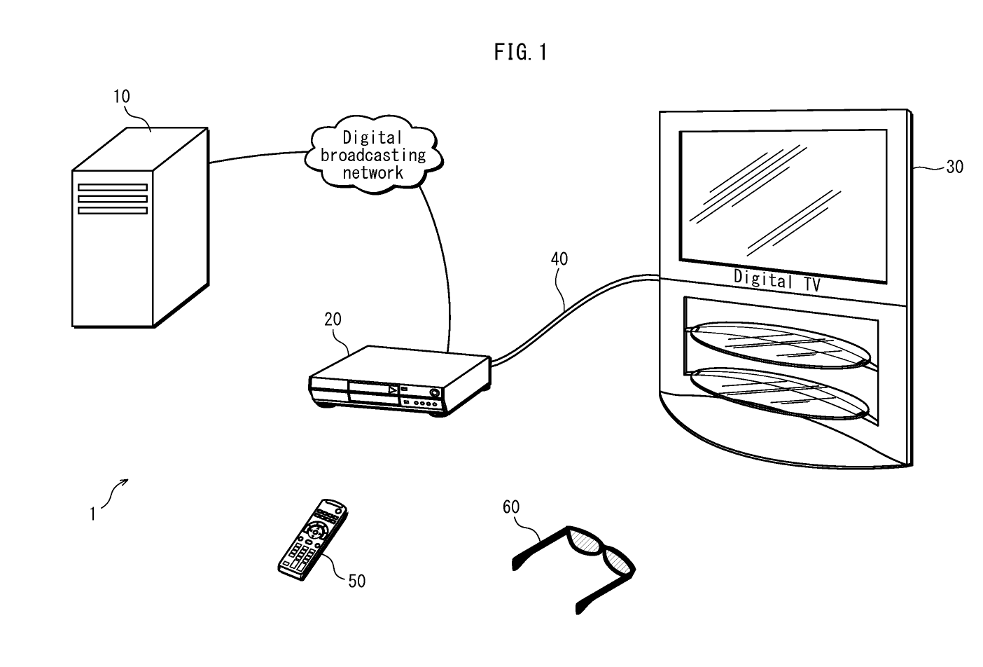

FIG. 1 is a system configuration diagram of an image processing system 1.

As shown, the image processing system 1 includes a transmission device 10, a Blu-ray Disc (hereinafter, BD) recorder 20, a digital television 30, an HDMI cable 40, a remote control 50, and 3D glasses 60. The transmission device 10, the BD recorder 20, and the digital television 30 are respective examples of a transmission device, a reception device, and a display device, pertaining to the present disclosure.

The transmission device 10 is a device installed at a broadcasting station for digital broadcasting. The transmission device 10 encodes a broadcast program made up of a plurality of programs, such as 2D or 3D programs, and transmits the broadcast program over digital broadcast waves. The transmission device 10 also decodes the broadcast program by referencing program information and determining whether or not each program (i.e., the 2D or 3D programs) has priority. When a program has priority, the transmission device generates a priority flag serving as information preventing a receiver from switching between display modes.

In the present Embodiment, the term receiver refers to the BD recorder 20 and the digital television 30. Also, the term display mode may refer to either of a 2D display mode and a 3D display mode, where the 2D display mode indicates a mode in which the receiver displays a 2D program and the 3D display mode indicates a mode in which the receiver displays a 3D program.

The BD recorder 20 receives the encoded broadcast program, decodes it, and outputs the result to the digital television 30 via the HDMI cable 40. Here, the HDMI cable 40 transfers a digital signal in a communication format conforming to the HDMI standard.

When outputting the broadcast program to the digital television 30, the BD recorder 20 makes a determination regarding program priority for the programs in the decoded broadcast program (i.e., the 2D or 3D programs). Then, when a program has priority and the display mode for the priority program differs from the display mode of a preceding program output immediately before, the BD recorder 20 changes the display mode of the priority program. That is, the 2D program may be converted into a 3D program, or the 3D program may be converted into a 2D program. Thus, the display mode is not changed when the priority program is output from the BD recorder 20 to the digital television 30.

The remote control 50 is an input device for inputting various instructions to the BD recorder 20. The user makes instructions on the remote control 50 in order to select a desired channel and so on, thus being able to input various instructions to the BD recorder 20.

When in the 3D display mode, the digital television 30 outputs a right-view image and a left-view image in alternation. The user is able to view the 3D program stereoscopically by wearing the 3D glasses 60, which are equipped with liquid crystal shutters.

### <1-2. Transmission Device 10 Configuration>

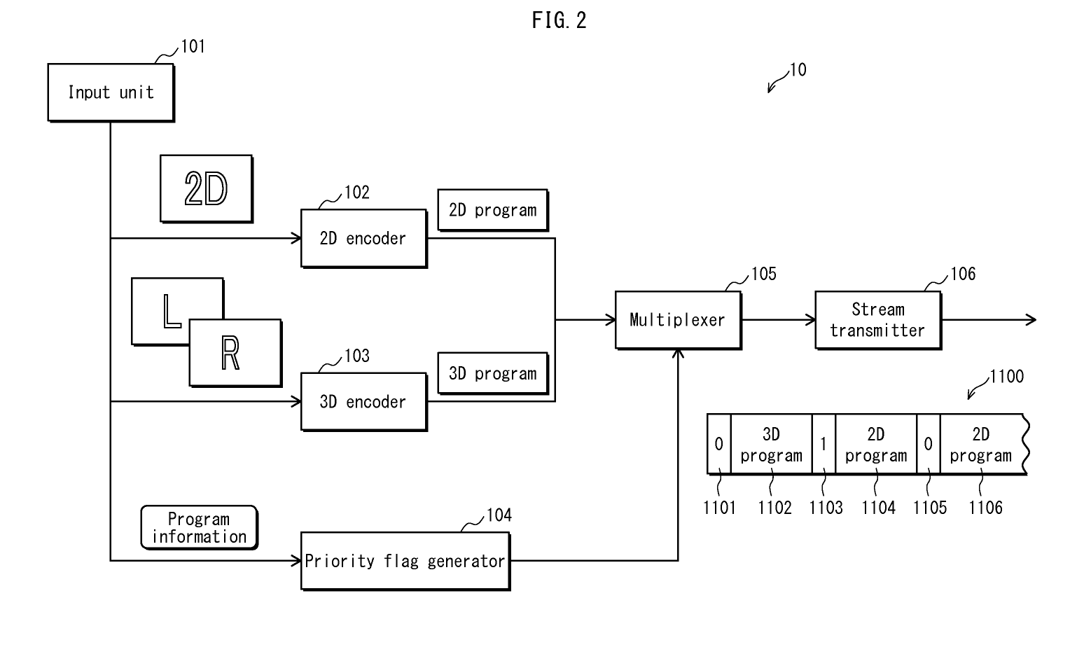

FIG. 2 is a block diagram illustrating the configuration of the transmission device 10. As shown, the transmission device 10 includes an input unit 101, a 2D encoder 102, a 3D encoder 103, a priority flag generation unit 104, a multiplexing unit 105, and stream transmission unit 106.

The transmission device 10 also includes a processor, Random Access Memory (hereinafter, RAM), Read-Only Memory (hereinafter, ROM), and a hard disk, though none of these are diagrammed. The functional blocks of the transmission device 10 may be realised as a hardware configuration, or as a computer program stored in ROM or on the hard disk and executed by the processor.

The input unit 101 receives the broadcast program created by a non-diagrammed program creation device and program information describing a broadcast program configuration. The broadcast program received by the input unit 101 is configured to include a plurality of 2D programs for 2D display and 3D programs for 3D display.

Each 2D program includes approximately 60 frames per second (hereinafter also abbreviated fps) of chronologically continuous interlaced images (hereinafter termed 2D source images). The 3D program includes approximately 60 fps of chronologically continuous interlaced images for each of a left view and a right view (hereinafter termed left-view source images and right-view source images).

The input unit 101 outputs 2D programs to the 2D encoder 102, outputs 3D programs to the 3D encoder 103, and outputs program information to the priority flag generation unit 104.

The 2D encoder 102 receives the 2D program and encodes the received 2D program using a 2D coding method (e.g., H.264).

The 3D encoder 103 receives the 3D program and encodes the received 3D program using a 3D coding method (e.g., H.264 MVC).

The priority flag generation unit 104 receives the program information and references the received program information to determine whether or not the program currently being processed by the 2D encoder 102 or by the 3D encoder 103 has priority. When the program currently being processed has been found to have priority, the priority flag generation unit 104 outputs a priority flag of one to the multiplexing unit 105. Likewise, when the program currently being processed has been found not to have priority, the priority flag generation unit 104 outputs a priority flag of zero to the multiplexing unit 105. The program information is described later.

The multiplexing unit 105 receives the 2D program encoded by the 2D encoder 102, the 3D program encoded by the 3D encoder 103, and later-described additional information. The multiplexing unit 105 also receives an audio stream from a non-diagrammed audio encoder.

The multiplexing unit 105 writes the priority flag received from the priority flag generation unit 104 and the additional information received from the 3D encoder 103 into Program Specific Information (hereinafter, PSI). The multiplexing unit 105 also writes a 3D flag into the PSI, thereby indicating whether each program in the broadcast program is a 2D program or a 3D program. In the present Embodiment, the 3D flag is set to zero to indicate a 2D program and is set to one to indicate a 3D program.

The multiplexing unit 105 multiplexes a video stream that includes the encoded 2D program and the encoded 3D program, the audio stream, the PSI, and any other multimedia streams, to generate a transport stream (hereinafter also abbreviated TS). The multiplexing unit 105 outputs the generated transport stream to the stream transmission unit 106.

The stream transmission unit 106 transmits the transport stream generated by the multiplexing unit 105 on digital broadcast waves.

The TS 1100 illustrated in FIG. 2 is a simplified transport stream as transmitted by the stream transmission unit 106. A 3D program 1102 is a leading program. The 3D program 1102 is followed by 2D program 1104, 2D program 1106, and so on, transmitted in order. Priority flag 1101 corresponds to the 3D program 1102. The priority flag 1101 is set to zero, thus indicating that the 3D program 1102 is a normal program. Priority flag 1103 corresponds to 2D program 1104. Priority flag 1103 is set to one, thus indicating that 2D program 1104 is a priority program. Priority flag 1105 corresponds to 2D program 1106. Priority flag 1105 is set to zero, thus indicating that 2D program 1106 is a normal program.

### <1-3. Coding Method Details>

The details of the 2D encoder 102 and the 3D encoder 103 are described next.

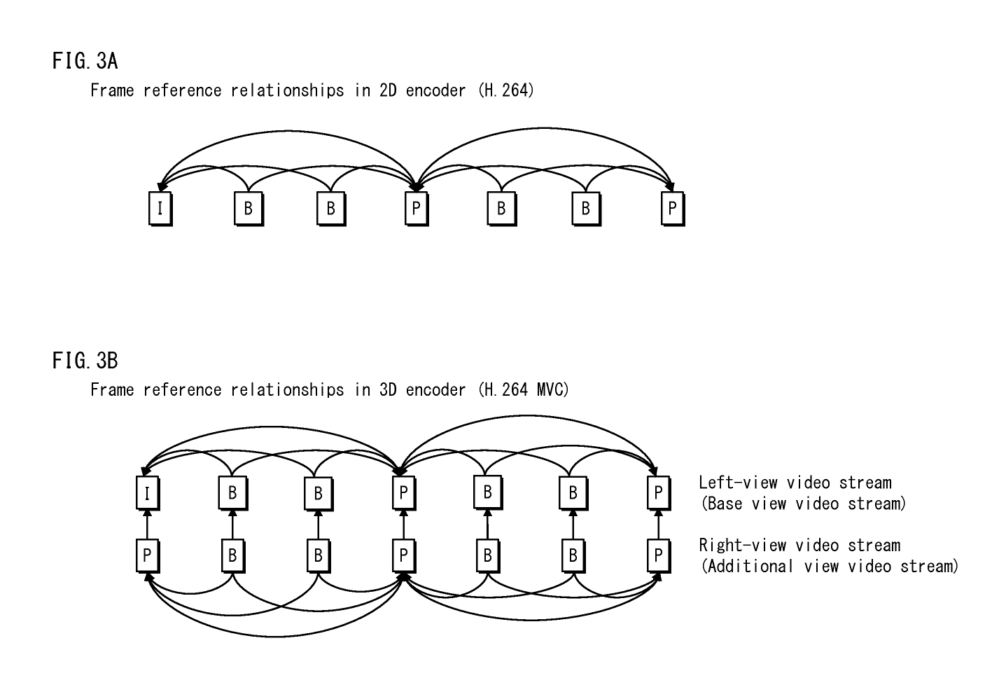

FIG. 3A illustrates the frame reference relationships within the encoded stream when the 2D encoder 102 applies the 2D coding method. Here, a frame is a unit of encoding. The stream encoded using the 2D coding method includes I-frames encoded using intra-frame predictive coding without relying on any reference frame, P-frames encoded using inter-frame predictive coding with reference to one previously-processed frame, and B-frames encoded using inter-frame predictive coding with reference to two previously-processed frames simultaneously. As such, the 2D encoder 102 uses a 2D coding method where chronological correlation is employed for inter-frame predictive coding. Examples include H.264/MPEG-4 AVC.

FIG. 3B illustrates the frame reference relationships within the encoded stream when the 3D encoder 103 applies the 3D coding method. The upper row of FIG. 3B corresponds to a left-view video stream obtained by encoding the left-view source images. Similarly, the lower row of FIG. 3B corresponds to a right-view video stream obtained by encoding the right-view source images.

The left-view video stream has the same reference structure as the 2D coding method depicted in FIG. 3A.

The right-view video stream uses compression that applies inter-frame predictive coding using inter-viewpoint correlation, in addition to the inter-frame predictive coding that applies chronological correlations. That is, the frames of the right-view video stream are compressed with reference to frames of the left-view video stream having the same presentation time stamp.

A video stream that can be played back individually, such as the left-view video stream, is termed a base view video stream. In contrast, a video stream such as the right-view video stream that is decodable after the base view video stream has been decoded, with reference to the frames making up the base view video stream is termed an additional view stream or a dependent view stream.

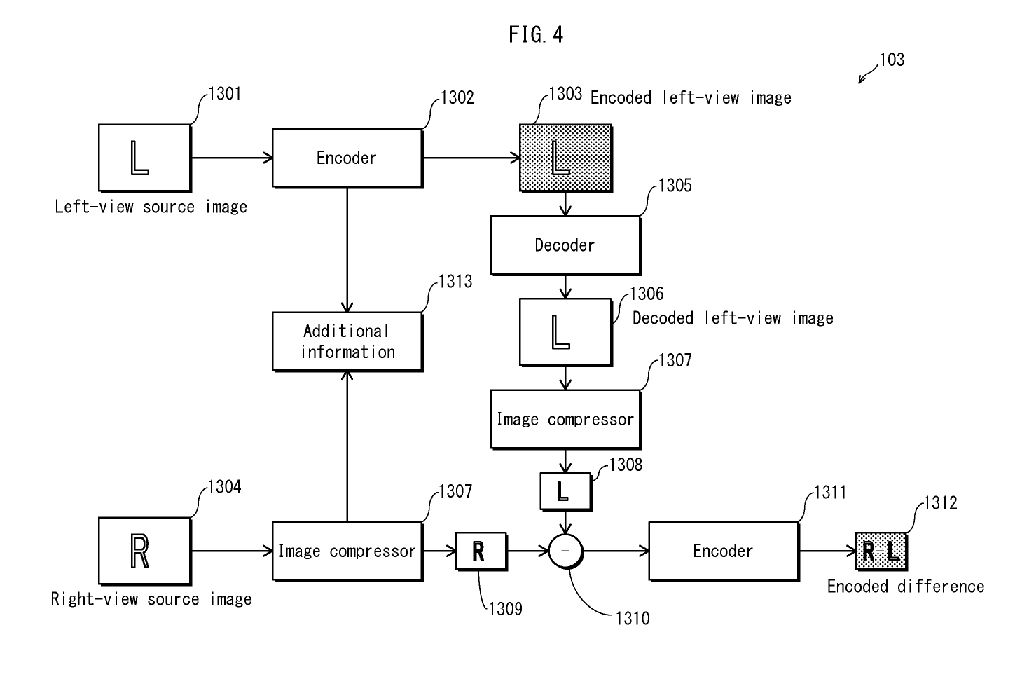

Next, the details of the encoding process by the 3D encoder 103 are described with reference to FIG. 4.

An encoder 1302 encodes the left-view source images 1301 and outputs left-view images. The left-view images 1303 are output sequentially by the encoder 1302 and enumerated into an encoded sequence that is the left-view video stream. In the present Embodiment, the left-view video stream corresponds to the base view video stream.

As described above, the right-view source images 1304 are encoded using a difference relative to left-view source images having the same time-stamp. As such, a decoding unit 1305 first decodes the encoded left-view images 1303 into decoded left-view images 1306. Then, in order to increase the compression ratio, an image compressor 1307 compresses the left-view images 1306, thereby decreasing the resolution and generating reduced images 1308. The image compressor 1307 also reduces the right-view source images 1304 to generate reduced images 1309. The image compressor 1307 may compress the left-view images 1306 and the right-view source images 1304 in the vertical direction only, in the horizontal direction only, or in the horizontal and vertical directions.

A difference calculator 1310 calculates a difference between the left-view reduced images 1308 and the right-view reduced images 1309. Encoder 1311 then encodes the calculated difference. The difference 1312 is output sequentially by encoder 1311 and enumerated into an encoded sequence that is the right-view video stream. In the present Embodiment, the right-view video stream corresponds to the additional view video stream.

The additional information generation unit 1313 generates additional information describing information such as the reduction factor used by the image compressor 1307, for each of the base view video stream and the additional view video stream. The additional information is output by the 3D encoder 103 to the multiplexing unit 105 and written into a Program Map Table (hereinafter, PMT) of the PSI by the multiplexing unit 105.

### <1-4. Regarding the Additional Information>

The following describes the data configuration and usage of the additional information.

The decoding process applied to the additional view video stream generated by the 3D encoder 103 is described first. The BD recorder 20 may also perform reversed encoding operations when decoding the additional view video stream. That is, the BD recorder 20 first decodes the encoded difference. Next, the BD recorder 20 reduces the encoded base view video stream and generates reduced images having a lower resolution. Then, reduced decoded images are generated through the addition of the decoded difference to the reduced images. Finally, the BD recorder 20 obtains the right-view images for display by expanding the reduced decoded images.

As such, the coding method used by the 3D encoder 103 produces decoded right-view images having a lower resolution than the left-view images. However, given that the user views the left-view images and the right-view images in alternation, the left-view images and the right-view images become fused in the user's mind, such that the lower resolution of the right-view images is not perceptible.

When, as described above, the BD recorder 20 converts a 3D program into a 2D program in order for the display mode of the priority program to match the display mode of the most recent preceding program, the user may experience some discomfort in the event that the left-view images are discarded and the right-view images, having lower resolution, are selected alone for output. As such, an additional information generation unit 1313 generates the additional information such that the appropriate images are selected when the BD recorder 20 converts a 3D program into a 2D program.

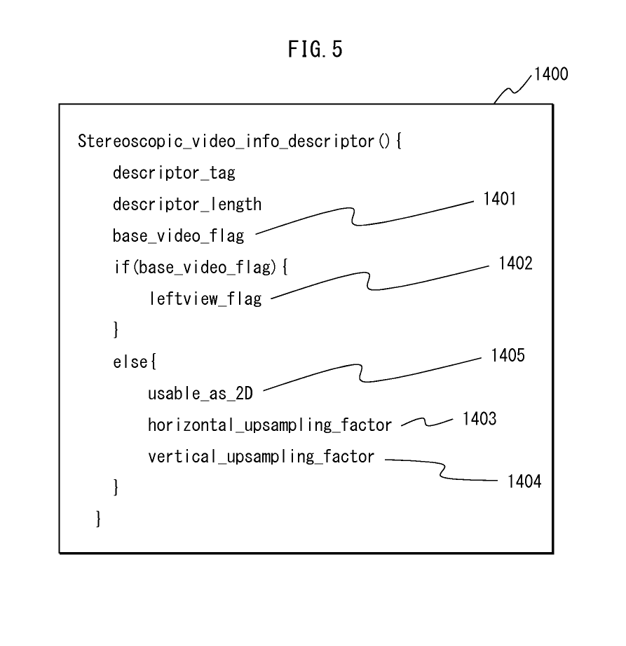

FIG. 5 illustrates an example of a data configuration for the additional information. The additional information 1400 illustrated by FIG. 5 includes a base video flag 1401 indicating whether the corresponding stream (i.e., the stream having the additional information 1400 added thereto) is a base view video stream or an additional view video stream, a left-view flag 1402 used when the corresponding stream is an additional view video stream to indicate whether the stream is a left-view video stream or a right-view video stream, a horizontal reduction factor 1403, a vertical reduction factor 1404, and a 2D usability flag 1405 indicating whether or not the corresponding stream is usable for output in the 2D display mode.

The additional information generation unit 1313 completes the additional information 1400 by writing the values indicated in FIG. 5 for the base view video stream and the additional view video stream at generation time.

When a value such as 50% is written into the horizontal reduction factor 1403 or into the vertical reduction factor 1404 indicating that reduction occurs, the additional information generation unit 1313 sets the 2D usability flag 140 to FALSE in order to prevent image quality degradation when the BD recorder 20 converts a 3D program into a 2D program. Conversely, when a value such as 100% is written into the horizontal reduction factor 1403 and into the vertical reduction factor 1404 indicating that no reduction occurs, the additional information generation unit 1313 sets the 2D usability flag 1405 to TRUE.

When the encoding process depicted in FIG. 4 is performed, the additional information generation unit 1313 sets the 2D usability flag 1405 of the additional information 1400 associated with the additional view video stream to FALSE.

### <1-5. Program Information Data Configuration>

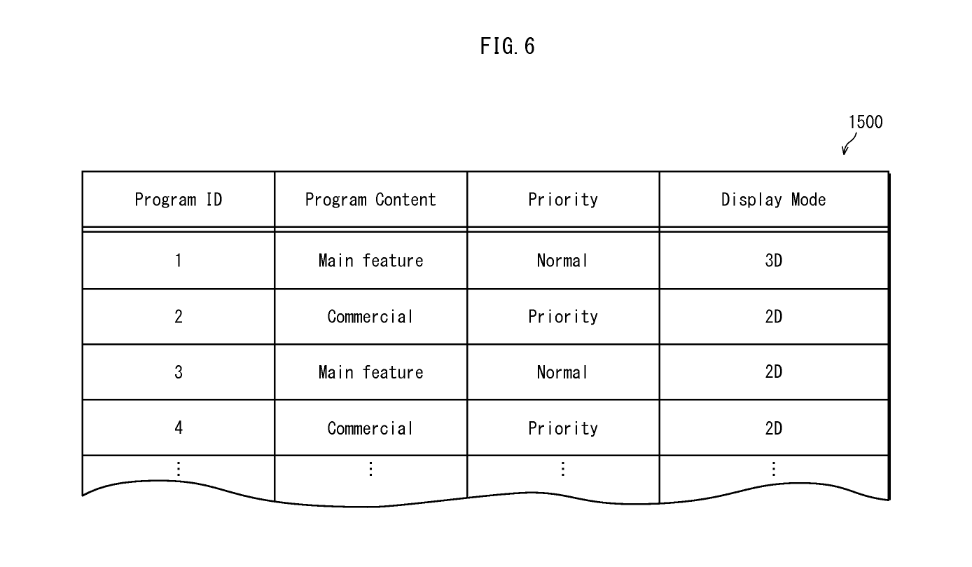

FIG. 6 illustrates the data configuration of the program information 1500. The program information 1500 is generated for each broadcast program and describes information pertaining to each program within the broadcast program. For example, the program information 1500 includes a program ID for each program, program content, a priority, and a display mode.

The program ID is a number indicating a transmission order for each program. The program content is a field indicating whether the program is a feature or a commercial. The priority is a field indicating whether the program is a normal program or a priority program. As described above, sponsor relationships mean that the broadcast station faces greater problems when commercials are not correctly displayed, than when feature programs are not correctly displayed. As such, in the present Embodiment, the commercials are defined as priority programs and the priority field thereof is accordingly set to Priority. Also, the feature program is defined as a normal program and the priority field thereof is set to Normal. The display mode indicates whether the program is a 2D program or a 3D program.

### <1-6. Transmission Device 10 Operations>

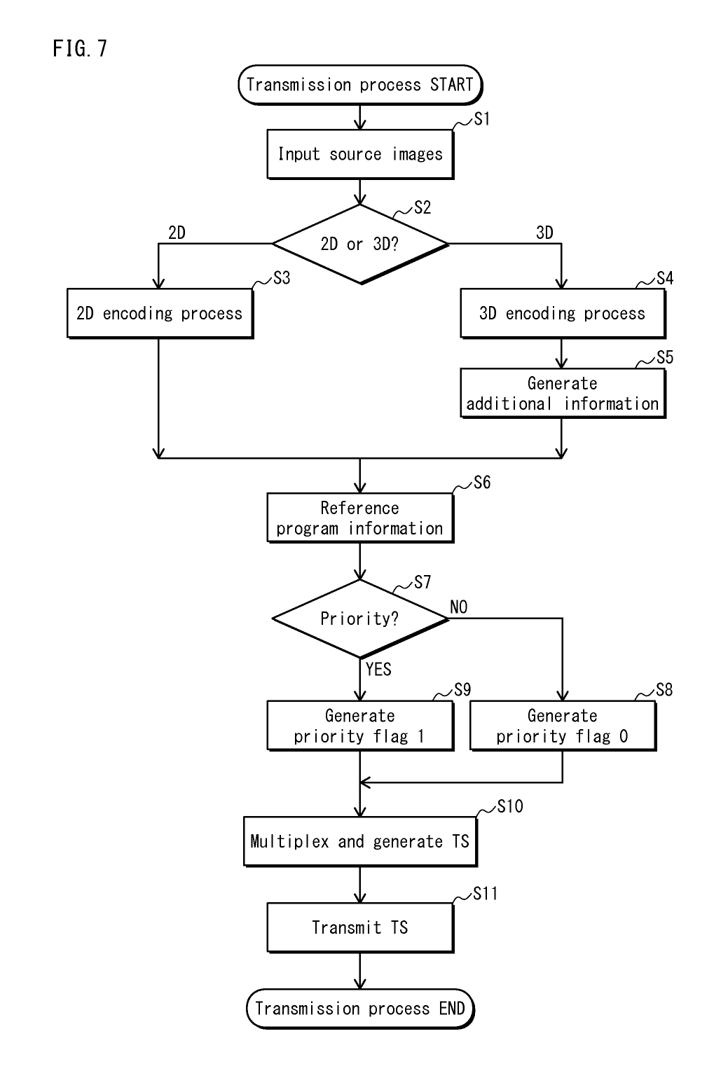

FIG. 7 is a flowchart depicting the operations of the transmission device 10.

The input unit 101 receives a program subject to processing (hereinafter termed a subject program) (step S1). The subject program is a 2D program or a 3D program within the broadcast program. Prior to step S1, the input unit 101 receives the program information corresponding to the broadcast program as input, and passes the received program information to the priority flag generation unit 104.

When the subject program input during step S1 is a 2D program (2D in step S2), the input unit 101 outputs the subject program to the 2D encoder 102. The 2D encoder 102 then encodes the subject program (step S3). The 2D encoder 102 outputs the encoded 2D program to the multiplexing unit 105.

When the subject program is a 3D program (3D in step S2), the input unit 101 outputs the subject program to the 3D encoder 103. The 3D encoder 103 then encodes the subject program to generate the base view video stream and the additional view video stream (step S4). The base view video stream and the additional view video stream are hereinafter referred to in combination as an encoded 3D program.

Subsequently, the 3D encoder 103 generates additional information for each of the base view video stream and the additional view video stream generated in step S4 (step S5). The 3D encoder 103 outputs the encoded 3D program and the additional information to the multiplexing unit 105.

The priority flag generation unit 104 references the program information received from the input unit 101 (step S6) and determines whether or not the subject program has priority. Here, the priority flag generation unit 104 is able to identify the subject program using the program ID. The priority flag generation unit 104 extracts the priority corresponding to the program ID of the subject program from the program information. When the priority field is set to Priority, the subject program has priority. When the priority field is set to Normal, the subject program does not have priority.

When the subject program has priority (YES in step S7), the priority flag generation unit 104 generates a priority flag of one (step S8) and outputs the results to the multiplexing unit 105.

When the subject program does not have priority (NO in step S7), the priority flag generation unit 104 generates a priority flag of zero (step S9) and outputs the results to the multiplexing unit 105.

The processing of steps S6 through S9 may be performed in parallel to steps S3 and S4.

The multiplexing unit 105 receives the encoded 2D program, the encoded 3D program, the PSI, the audio stream, and other multimedia streams, and performs multiplexing thereon to generate the transport stream (step S10).

The stream transmission unit 106 transmits the transport stream generated by the multiplexing unit 105 on digital broadcast waves (step S11).

### <1-7. BD Recorder 20 Configuration>

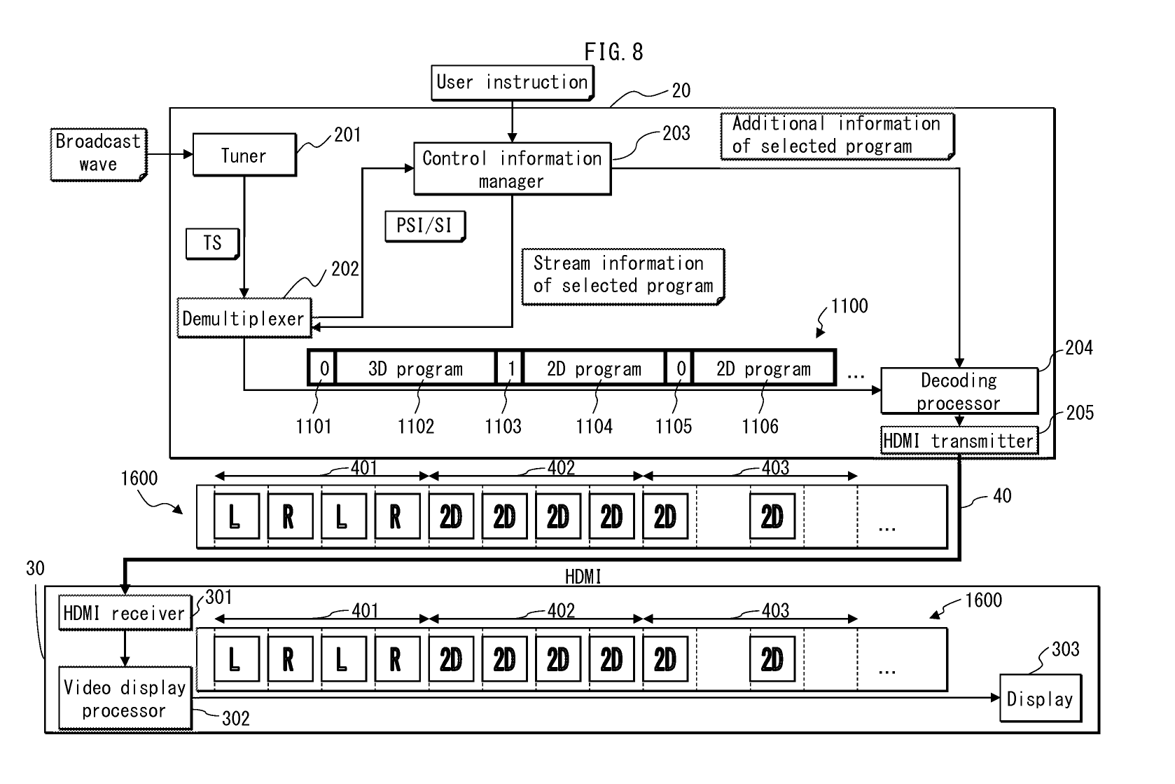

FIG. 8 is a block diagram illustrating the configuration of the BD recorder 20 and the digital television 30.

As shown, the BD recorder 20 includes a tuner 201, a demultiplexer 202, a control information manager 203, a decoding processor 204, and an HDMI transmitter 205.

The BD recorder 20 also includes a processor, RAM, ROM, and a hard disk, none of which are diagrammed. The functional blocks of the BD recorder 20 may be realised as a hardware configuration, or as a computer program stored in ROM or on the hard disk and executed by the processor.

The tuner 201 receives and demodulates the digital broadcast wave to obtain the transport stream.

The demultiplexer 202 demultiplexes the transport stream, separating out a control information stream, such as the PSI, and streams corresponding to a program selected by the user such as an audio stream and video streams. The demultiplexer 202 outputs the control information stream to the control information manager 203 and outputs the video stream to the decoding processor 204.

The control information manager 203 receives a program selection from the user via the remote control 50. The control information manager 203 receives the control information stream from the demultiplexer 202. The control information stream describes stream information (e.g., ID) for designating an elemental steam within the selected program. The control information manager 203 notifies the demultiplexer 202 of the IDs of elemental streams in the selected program, thereby making a request to the demultiplexer 202 to demultiplex the elemental streams having those IDs. The control information manager 203 also extracts a priority flag and additional information corresponding to the selected program from the control information stream, and outputs these to the decoding processor 204.

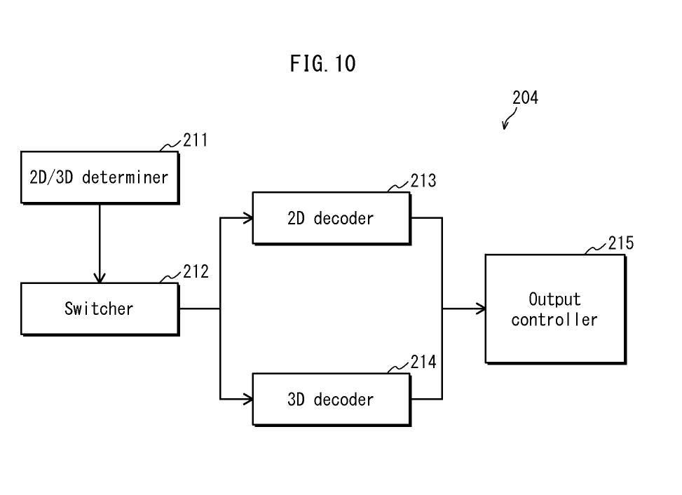

As shown in FIG. 10, the decoding processor 204 includes a 2D/3D determiner 211, a switcher 212, a 2D decoder 213, a 3D decoder 214, and an output controller 215.

The 2D/3D determiner 211 references the 3D flag in each program in order to sort the programs among the video streams received from the demultiplexer 202 into those for the 2D decoder 213 and those for the 3D decoder by determining whether the programs are 2D or 3D programs. The 2D/3D determiner 211 outputs the programs to the switcher 212 along with determination results.

The switcher 212 switches between connecting the 2D/3D determiner 211 to the 2D decoder 213 and to the 3D decoder 214. Upon receiving a 2D program from the 2D/3D determiner 211, the switcher 212 connects the 2D/3D determiner 211 to the 2D decoder 213 and outputs the received 2D program to the 2D decoder 213. Likewise, upon receiving a 3D program from the 2D/3D determiner 211, the switcher 212 connects the 2D/3D determiner 211 to the 3D decoder 214 and outputs the received 3D program to the 3D decoder 214.

The 2D decoder 213 performs a decoding process according to the coding method used by the 2D encoder 102 of the transmission device 10.

The 3D decoder 214 performs a decoding process according to the coding method used by the 3D encoder 103 of the transmission device 10.

The output controller 215 receives the decoded 2D program from the 2D decoder 213. The output controller 215 also receives the decoded 3D program from the 3D decoder 214. The output controller 215 references the values of the priority flag corresponding to each received 2D program and 3D program. When a received program has priority, and the display mode of the priority program differs from the display mode of the preceding program, the output controller 215 changes the display mode of the priority program. That is, the 2D program may be converted into a 3D program, or the 3D program may be converted into a 2D program by the output controller 215.

The HDMI transmitter 205 includes an HDMI connector for connecting the HDMI cable 40. Upon receiving an output program that includes the 2D and/or 3D programs from the decoding processor 204, the HDMI transmitter 205 transmits the received output program to the digital television 30 via the HDMI cable 40.

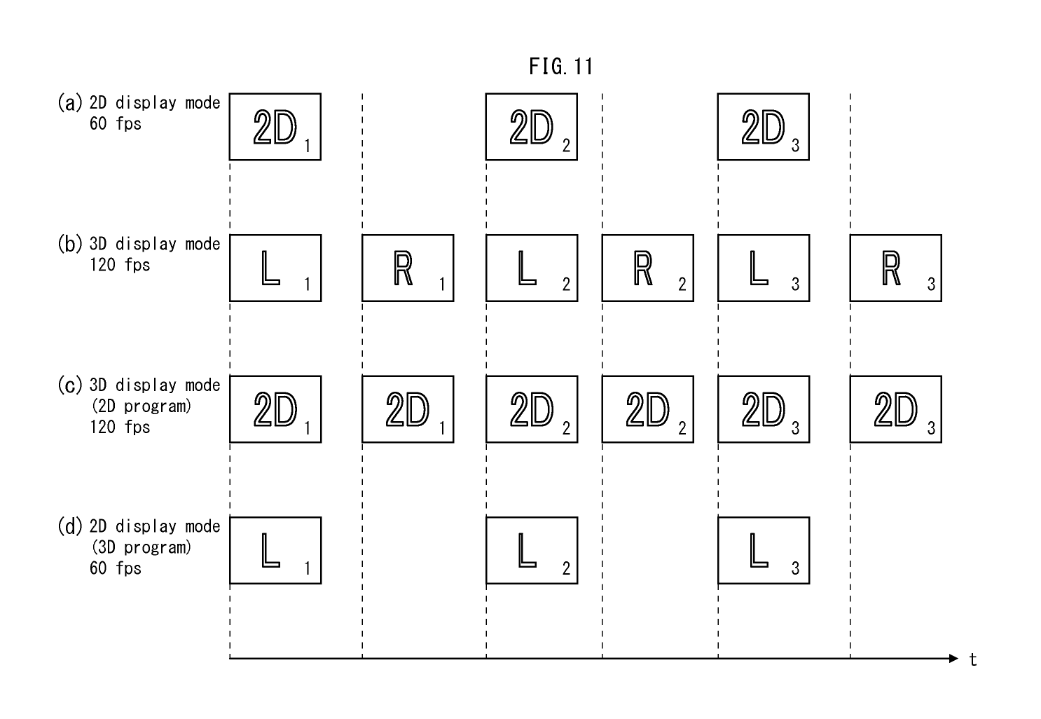

The following describes a change in display mode performed by the output controller 215, with reference to FIG. 11. The horizontal axis of FIG. 11 represents time.

Tier (a) represents the frame rate when a 2D program is being displayed in the 2D display mode. The HDMI cable 40 transfers the frames of the 2D program (labelled 2D) at 60 fps.

Tier (b) represents the frame rate when a 3D program is being displayed in the 3D display mode. In order to display the 2D program at the same frame rate as the 2D program, the HDMI cable 40 transmits the left-view frames (labelled L) and the right-view frames (labelled R) making up the 3D program in alternation, at 120 fps. That is, the 3D display mode requires frames to be transferred at twice the frame rate of the 2D display mode.

When the 2D program of tier (a) is changed to the 3D display mode, the output controller 215 copies each frame (labelled 2D) making up the 2D program as shown in tier (c), thereby doubling the amount of data, to generate a 3D program without parallax. The HDMI cable 40 transfers the original frames and the copied frames in alternation, at 120 fps.

When the 3D program of tier (b) is changed to the 2D display mode, the output controller 215 selects the left-view frames (labelled L) from the 3D program and discards the right-view frames, as shown in tier (d), thus halving the amount of data and generating a 2D program. The HDMI cable 40 transfers the left-view frames at 60 fps.

### <1-8. Digital Television 30 Configuration>

As shown in FIG. 8, the digital television 30 includes an HDMI receiver 301, a video display processor 302, and a display 303.

The digital television 30 also includes a processor, RAM, ROM, and a hard disk, none of which are diagrammed. The functional blocks of the digital television 30 may be realised as a hardware configuration, or as a computer program stored in ROM or on the hard disk and executed by the processor.

The HDMI receiver 301 includes an HDMI connector for connecting the HDMI cable 40. The HDMI receiver 301 receives the output program transmitted by the HDMI transmitter 205 via the HDMI cable 40. When a change in display mode occurs in the output program being transmitted and received by the HDMI transmitter 205 and the HDMI receiver 301, the transmission and reception of the output program is stopped and a communication mode for a control signal is reset in order to change the transfer rate.

Upon receiving the output program from the HDMI receiver 301, the video display processor 302, which has an internal frame buffer, stores the frames of the output program in the frame buffer. The frame buffer includes a 2D display buffer and a 3D display buffer, where the 3D display buffer further includes a left-view buffer and a right-view buffer.

The video display processor 302 stores the frames of the 2D program in the 2D display buffer. The video display processor 302 stores the left-view frame frames of the 3D program in the left-view buffer, and stores the right-view frame of the 3D program in the right-view buffer.

When there is a change to the 3D display mode in which a 3D program without parallax is being generated from a 2D program, as in tier (c) of FIG. 11, the video display processor 302 stores the original frames in the left-view buffer and stores the copied frames in the right-view buffer. Similarly, when there is a change to the 2D display mode in which a 2D program is generated from a 3D program, as in tier (d) of FIG. 11, the video display processor 302 stores the left-view frames in the 2D display buffer.

The display 303 is, for example, a liquid crystal display. When in the 2D display mode, the display 303 reads the frames in the 2D display buffer and displays the frames so read at a frequency of 60 Hz. When in the 3D display mode, the display 303 reads the left-view frames and the right-view frames from the respective left-view buffer and right-view buffer in alternation, and displays the frames so read in alternation at a frequency of 120 Hz.

### <1-9. BD Recorder 20 and Digital Television 30 Operations>

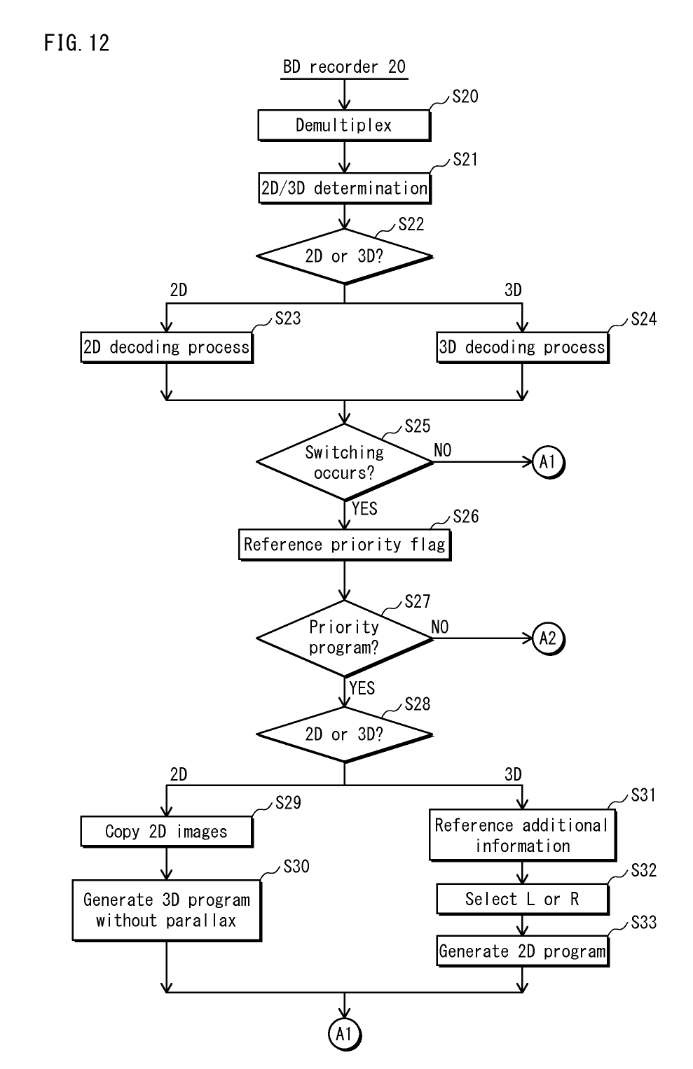

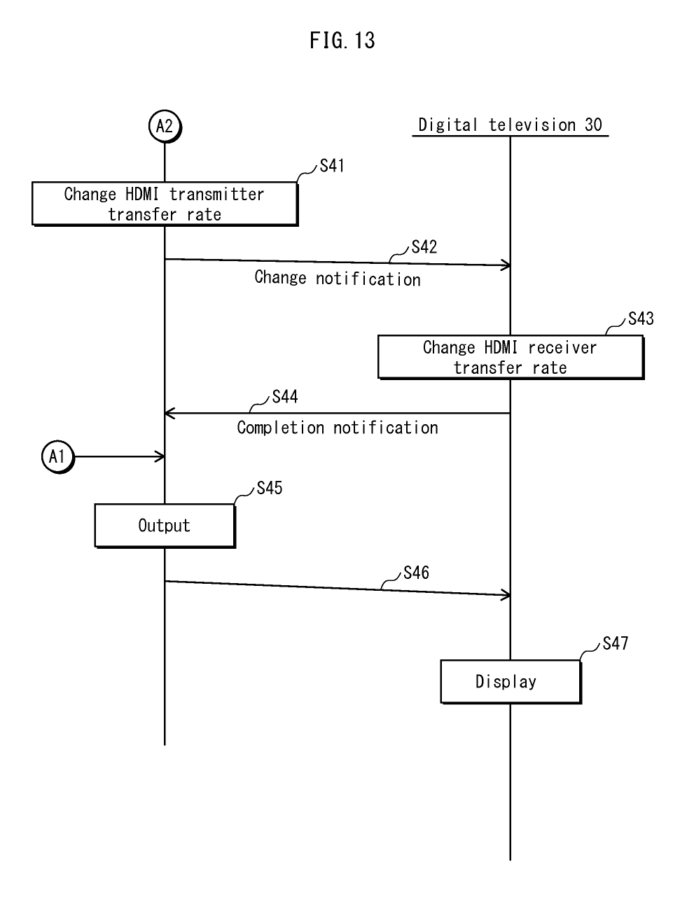

FIGS. 12 and 13 are flowcharts of the operations performed by the BD recorder 20 and the digital television 30.

The tuner 201 receives the broadcast program and demodulates it into a TS. The demultiplexer 202 demultiplexes the TS (step S20). The demultiplexer 202 sequentially outputs the demultiplexed video streams (i.e., programs) to the decoding processor 204.

The 2D/3D determiner 211 of the decoding processor 204 references the 3D flag to determine whether or not the program subject to processing (hereinafter also termed a subject program) is a 2D program or a 3D program (step S21). When the 3D flag is set to zero, the subject program is a 2D program. When the 3D flag is set to one, the subject program is a 3D program.

When the subject program is a 2D program (2D in step S22), the 2D decoder 213 performs a decoding process (step S23). When the subject program is a 3D program (3D in step S22), the 3D decoder 214 performs a decoding process (step S24).

The output controller 215 determines whether or not a change of display mode has occurred between the preceding program and the subject program. For example, a change of display mode occurs when the preceding program is a 2D program and the subject program is a 3D program, and when the preceding program is a 3D program and the subject program is a 2D program.

When there is no change in display mode (NO in step S25), the process advances to step S45.

When a change in display mode occurs (YES in step S25), the output controller 215 references the priority flag of the subject program (step S26) to determine whether or not the subject program has priority. Specifically, the subject program has priority when the priority flag is set to one. Conversely, the subject program does not have priority when the priority flag is set to zero.

When the subject program does not have priority (NO in step S27), the process advances to step S41.

When the subject program has priority (YES in step S27), and is a 2D program (2D in step S28), the output controller 215 copies the original 2D frames in the subject program (step S29) and generates a 2D program without parallax that is playable in the 3D display mode (step S30). Afterward, the process advances to step S45.

When the subject program has priority (YES in step S27), and is a 3D program (3D in step S28), the output controller 215 references the additional information 1400 associated with the subject program (step S31) and selects one of the left-view frames and the right-view frames (step S32). The output controller 215 selects the left-view frames when flag 1402 indicates the right-view video stream and flag 1405 is set to FALSE within the additional information 1400 associated with the additional view video stream. The output controller 215 outputs only the frames selected in step S32 to the HDMI transmitter 205 and discards the frames that were not selected, thus generating a 2D program that is playable in the 2D display mode (step S33). Afterward, the process advances to step S34.

When a change of display mode occurs and the subject program does not have priority, the HDMI transmitter 205 performs a communication mode reset to change the transfer rate (step S41). The HDMI transmitter 205 then transmits a transfer rate change notification to the HDMI receiver 301 of the digital television 30 (step S42).

Upon receiving the change notification, the HDMI receiver 301 also performs the communication mode reset to change the transfer rate (step S43). The HDMI receiver 301 then transmits a transfer rate change completion notification to the HDMI transmitter 205 (step S44).

Upon receiving the completion notification, the HDMI transmitter 205 outputs the subject program to the HDMI cable 40 (step S45). The HDMI receiver 301 receives the subject program via the HDMI cable 40 (step S46). Upon receiving the subject program from the HDMI receiver 301, the video display processor 302 outputs the display 303. The display 303 displays the subject program (step S47).

The specific operations performed by the BD recorder 20 upon receiving the TS 1100 described in FIG. 8 are described next.

The decoding processor 204 first decodes 3D program 1102. This produces a sequence of images such as interval 401 of output program 1600. The decoding processor 204 then decodes 2D program 1104. Priority flag 1103 is set to one, thus indicating that 2D program 1104 is a priority program. A change of display mode occurs between 2D program 1104, being output as-is, and 3D program 1102, which is the preceding program. The output controller 215 copies the 2D images making up 2D program 1104 and generates a 3D program without parallax. This produces a sequence of images such as interval 402 of output program 1600. The decoding processor 204 then decodes 2D program 1106. Priority flag 1105 is set to zero, thus indicating that 2D program 1106 is not a priority program. The 2D program 1106 is then output in the 2D display mode. This produces a sequence of images such as interval 403 of output program 1600.

Intervals 401 and 402 of output program 1600 have the same frame rate. There is thus no need for the HDMI transmitter 205 and the HDMI receiver 301 to perform a communication mode reset.

Intervals 402 and 403 of output program 1600 have different frame rates. As such, the HDMI transmitter 205 and the HDMI receiver 301 perform the communication mode reset when the frame rate is changed. Thus, the data transmission process by the HDMI cable 40 is interrupted for a few seconds, and a leading portion of 2D program 1106 may not be displayed on the display 303.

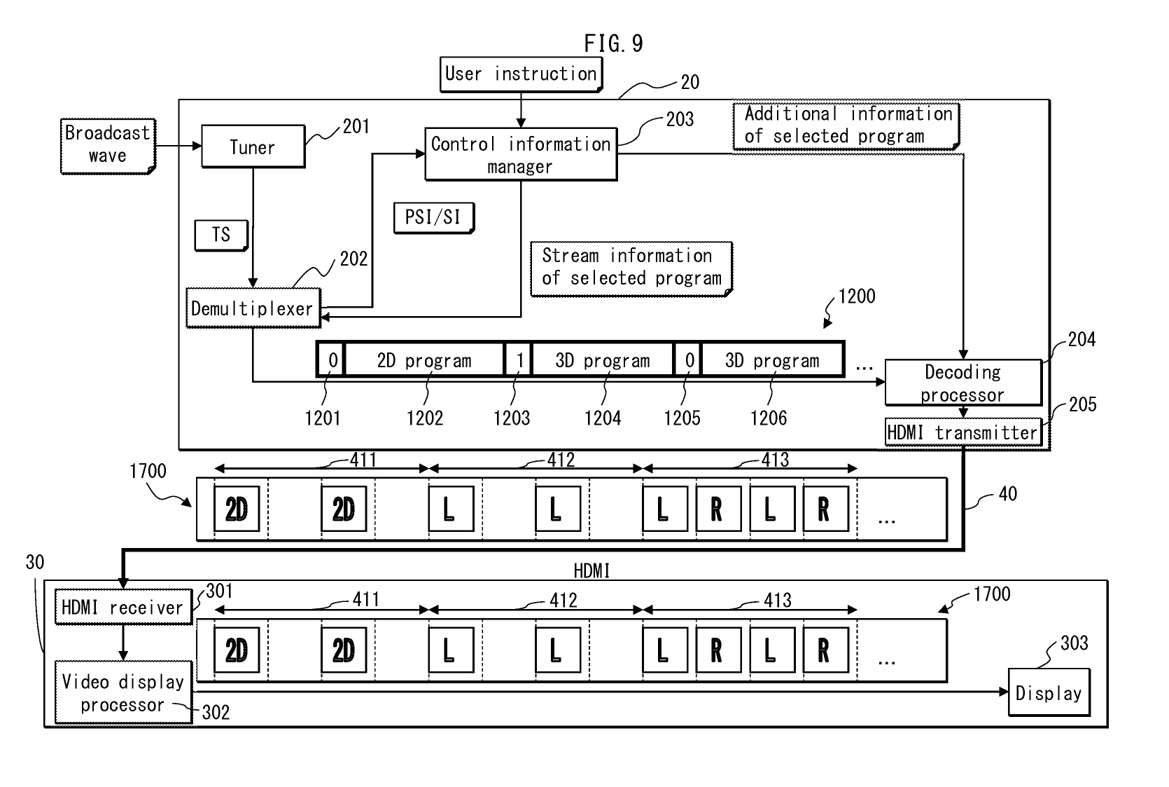

The specific operations performed by the BD recorder 20 upon receiving the TS 1200 described in FIG. 9 are described next.

The decoding processor 204 first decodes 2D program 1202. This produces a sequence of images such as interval 411 of output program 1700. The decoding processor 204 then decodes 3D program 1204. Priority flag 1203 is set to one, thus indicating that 3D program 1204 is a priority program. A change of display mode occurs between 3D program 1204, being output as-is, and 2D program 1202, which is the preceding program. The output controller 215 selects the left-view images among the images making up 3D program 1204 and generates a 2D program. This produces a sequence of images such as interval 412 of output program 1700. The decoding processor 204 then decodes 3D program 1206. Priority flag 1205 is set to zero, thus indicating that 3D program 1206 is not a priority program. 3D program 1206 is then output in the 3D display mode. This produces a sequence of images such as interval 413 of output program 1700.

Intervals 411 and 412 of output program 1700 have the same frame rate. There is thus no need for the HDMI transmitter 205 and the HDMI receiver 301 to perform a communication mode reset.

Intervals 412 and 413 of output program 1700 have different frame rates. As such, the HDMI transmitter 205 and the HDMI receiver 301 perform the communication mode reset when the frame rate is changed. Thus, the data transmission process by the HDMI cable 40 is interrupted for a few seconds, and a leading portion of 3D program 1206 may not be displayed on the display 303.

### 2. Embodiment 2

An image processing system pertaining to Embodiment 2 is described below, with reference to the accompanying drawings.

### <2.1 System Overview>

The image processing system of Embodiment 2 includes a transmission device 10a, a BD recorder 20a, a digital television 30a, a HDMI cable 40, a remote control 50, and 3D glasses 60.

In Embodiment 1, described above, the BD recorder 20 functions to convert a 2D program into a 3D program or to convert a 3D program into a 2D program in order to constrain changes in transfer rate occurring in the HDMI cable when a priority program is transmitted. In contrast, Embodiment 2 has the transmission device 10a function to convert 2D programs into 3D programs and to convert 3D programs into 2D programs.

### <2-2. Transmission Device 10a Configuration>

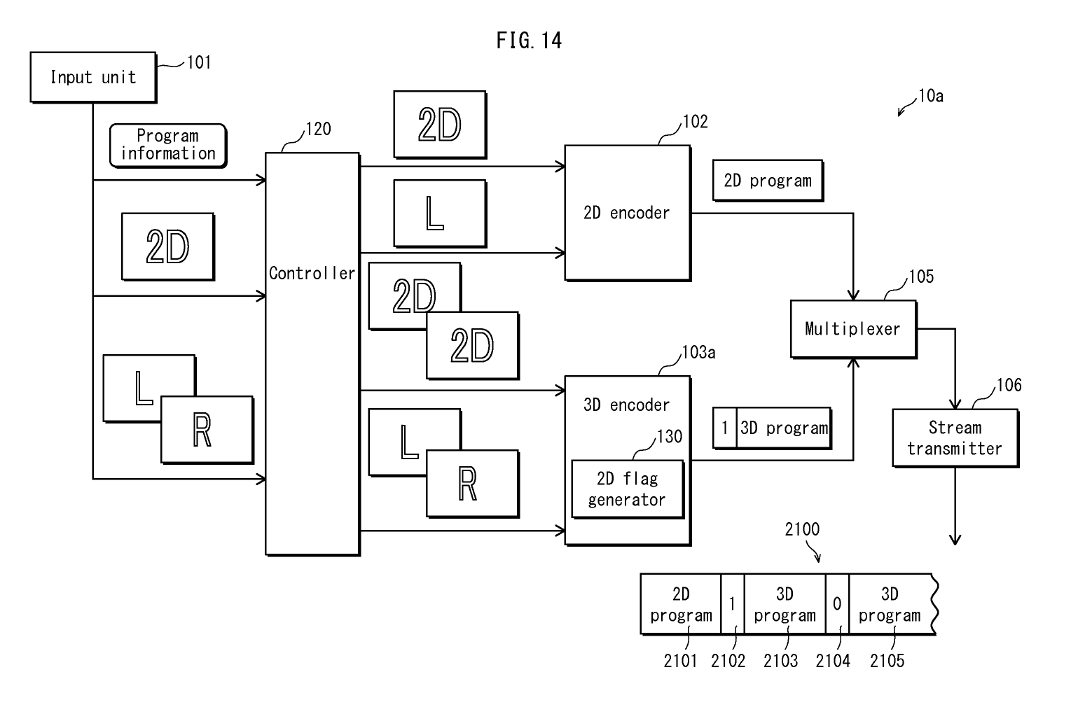

FIG. 14 is a block diagram illustrating the configuration of the transmission device 10a. As shown, the transmission device 10a includes an input unit 101, a controller 120, a 2D encoder 102, a 3D encoder 103a, a multiplexer 105, and stream transmitter 106. The 3D encoder 103a also includes a 2D flag generator 130. Components having the same function as those of the transmission device 10 from Embodiment 1 use the same reference signs thereas.

The transmission device 10a also includes a processor, RAM, ROM, and a hard disk, none of which are diagrammed. The functional blocks of the transmission device 10a may be realised as a hardware configuration, or as a computer program stored in ROM or on the hard disk and executed by the processor.

The controller 120 receives a broadcast program that includes a plurality of 2D programs and 3D programs from the input unit 101, and program information describing the broadcast program.

The controller 120 references the program information to specify a priority program, and checks the respective display modes of the specified priority program and a preceding program output immediately prior. When the display modes of the priority program and the preceding program differ, the controller 120 converts a 2D program into a 3D program or converts a 3D program into a 2D program in order to constrain the occurrence of a change in display mode when the receiver displays the priority program.

The 2D encoder 102 receives a 2D program from the controller 120 and encodes the received 2D program using a 2D coding method. Here, the 2D program encoded by the 2D encoder 102 includes a 2D program generated by a program creation device, and a 2D program generated from a 3D program by the controller 120.

The 3D encoder 103a receives a 3D program from the controller 120 and encodes the received 3D program using a 3D coding method. Here, the 3D program encoded by the 3D encoder 103a includes a 3D program generated by a program creation device, and a 3D program generated from a 2D program by the controller 120. Upon receiving the 3D program from the controller 120, the 3D encoder 103a notifies the controller 120 when the 3D program has no parallax due to having been generated from the 2D program.

The 2D flag generator 130 generates a 2D flag indicating whether or not the 3D program encoded by the 3D encoder 103a lacks parallax due to having been generated from a 2D program. The 2D flag generator 130 generates a 2D flag reading one when the encoded 3D program lacks parallax due to having been generated from a 2D program. The 2D flag generator 130 generates a 2D flag reading zero when the encoded 3D program has not been generated from a 2D program. The 2D flag is used by the receiver to delete redundant frames.

The 3D encoder 103a outputs the encoded 3D program to the multiplexer 105 with the 2D flag added thereto.

In Embodiment 2 and in the later-described Embodiment 3, the receiver does not perform any processing for converting a 2D program into a 3D program. As such, the 3D encoder 103a does not generate additional information 1400.

The TS 2100 illustrated in FIG. 14 is a simplified transport stream as transmitted by the stream transmitter 106. A 2D program 2101 is a leading program. The 2D program 2101 is followed by a 3D program 2103, a 2D program 2105, and so on, transmitted in order. 2D flag 2102 corresponds to 3D program 2103. Given that 2D flag 2102 reads one, 3D program 2103 is identified as having originally been a 2D program, converted into a 3D program that has no parallax by the controller 120. 2D flag 2104 corresponds to 3D program 2105. Given that 2D flag 2104 reads zero, 3D program 2105 is identified as not being a 2D program converted into a 3D program that has no parallax by the controller 120.

### <2-3. Transmission Device 10a Operations>

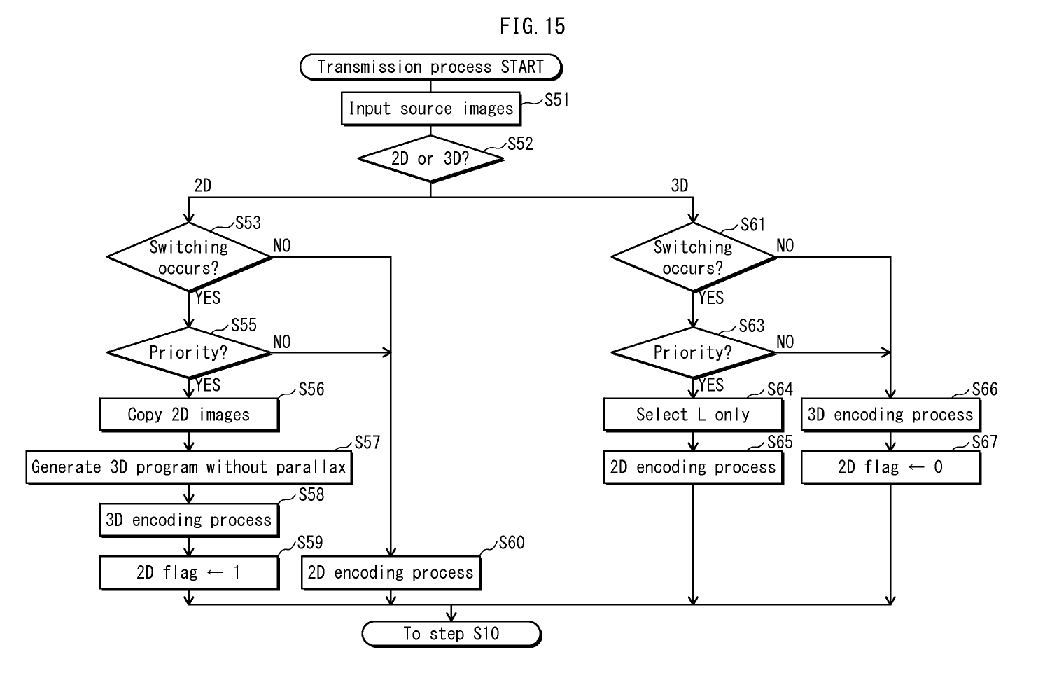

The following describes the operations of the transmission device 10a with reference to the flowchart of FIG. 15.

The input unit 101 receives a program subject to processing (hereinafter termed a subject program) (step S51). The subject program is a 2D program or a 3D program within the broadcast program. The input unit 101 passes the received subject program to the controller 120. Prior to step S51, the input unit 101 receives the program information corresponding to the broadcast program as input, and passes the received program information to the controller 120.

Upon receiving the subject program, the controller 120 references the display mode field in the program information to determine whether the subject program is a 2D program or a 3D program.

When the subject program is a 2D program (2D in step S52), the controller 120 references the display mode field of the program information to determine whether the preceding program output immediately before the subject program is a 2D program or a 3D program. The controller 120 further determines whether a change in display mode occurs in the receiver, according to the determination results.

When the preceding program is a 2D program, no change in display mode occurs in the receiver (NO in step S53). The controller 120 outputs the subject program to the 2D encoder 102 as-is. Afterward, the process advances to step S60.

When the preceding program is a 3D program, a change in display mode occurs in the receiver (YES in step S53). The controller 120 references the priority field of the program information to determine whether or not the subject program has priority.

When the subject program does not have priority (NO in step S55), no problem occurs in the event of a change in display mode. The controller 120 outputs the subject program to the 2D encoder 102. Afterward, the process advances to step S60.

When the subject program has priority (YES in step S55), a problem occurs in the event of a change in display mode. The controller 120 copies the 2D images in the subject program (step S56) and generates a 3D program with no parallax that is viewable in the 3D display mode (step S57). The controller 120 outputs the 3D program without parallax to the 3D encoder 103a.

Upon receiving the subject program, the 3D encoder 103a then encodes the subject program to generate the base view video stream and the additional view video stream (step S58). Next, the 2D flag generator 130 generates a 2D flag reading one (step S59). The flag is added to the encoded 3D program. The process then continues as explained in steps S10 and onward of Embodiment 1.

The 2D encoder 102 then acquires and encodes the subject program (step S60). The process then continues as explained in steps S10 and onward of Embodiment 1.

When the subject program is a 3D program (3D in step S52), the controller 120 references the display mode field of the program information to determine whether the preceding program output immediately before the subject program is a 2D program or a 3D program. The controller 120 further determines whether a change in display mode occurs in the receiver, according to the determination results.

When the preceding program is a 2D program, a change in display mode occurs in the receiver (YES in step S61). The controller 120 references the priority field of the program information to determine whether or not the subject program has priority.

When the subject program does not have priority (NO in step S63), no problem occurs in the event of a change in display mode. The controller 120 outputs the subject program to the 3D encoder 102. Afterward, the process advances to step S67.

When the subject program has priority (YES in step S63), a problem occurs in the event of a change in display mode. The controller 120 selects the left-view images of the subject program, only, for output to the 2D encoder 102.

The 2D encoder 102 receives the left-view images from the controller 120 and encodes the received left-view images (step S65). The process then continues as explained in steps S10 and onward of Embodiment 1.

When the preceding program is a 3D program, no change in display mode occurs in the receiver (NO in step S61). The controller 120 outputs the subject program to the 3D encoder 103a as-is.

The 3D encoder 103a then encodes the subject program to generate the base view video stream and the additional view video stream (step S66). Next, the 2D flag generator 130 generates a 2D flag reading zero (step S67). The flag is added to the encoded 3D program. The process then continues as explained in steps S10 and onward of Embodiment 1.

### <2-4. BD Recorder 20a Configuration>

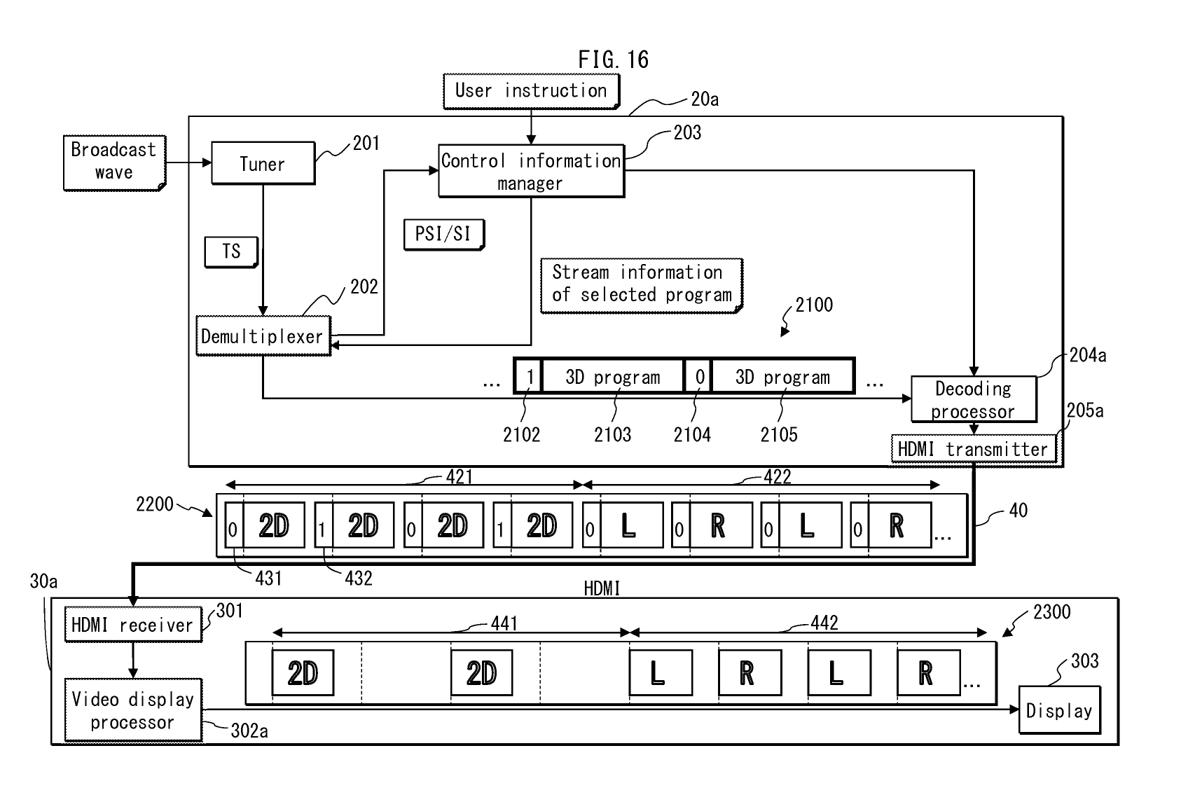

FIG. 16 is a block diagram illustrating the configurations of the BD recorder 20a and the digital television 30a.

As shown, the BD recorder 20a includes a tuner 201, a demultiplexer 202, a control information manager 203, a decoding processor 204a, and an HDMI transmitter 205a.

The BD recorder 20a also includes a processor, RAM, ROM, and a hard disk, none of which are diagrammed. The functional blocks of the BD recorder 20a may be realised as a hardware configuration, or as a computer program stored in ROM or on the hard disk and executed by the processor.

The tuner 201, the demultiplexer 202, and the control information manager 203 are each configured identically to the corresponding components of Embodiment 1.

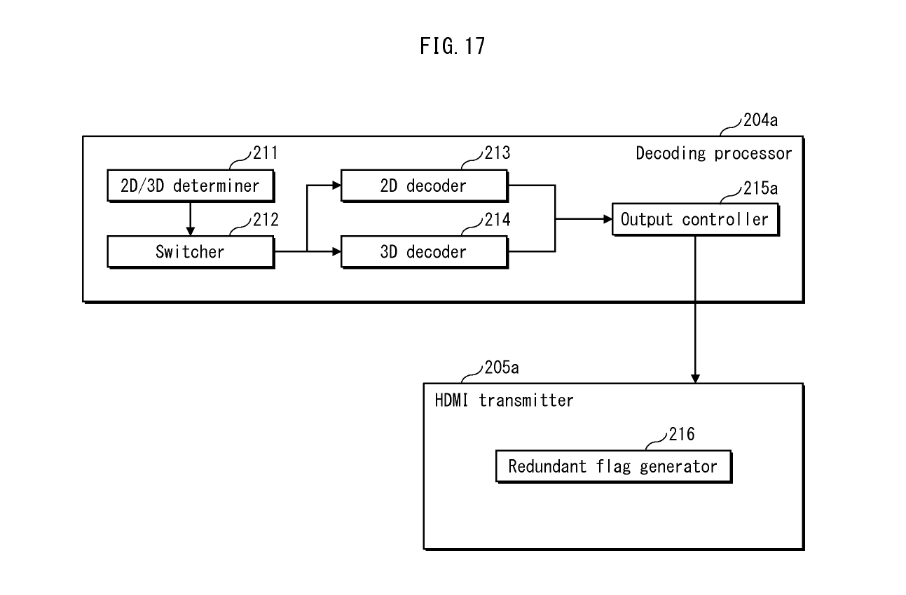

The following describes the decoding processor 204a and the HDMI transmitter 205a with reference to FIG. 17. As shown in FIG. 17, the decoding processor 204a includes a 2D/3D determiner 211, a switcher 212, a 2D decoder 213, a 3D decoder 214, and an output unit 215a. The HDMI transmitter 205a further includes a redundant flag generator 216.

The 2D/3D determiner 211, the switcher 212, the 2D decoder 213, and the 3D decoder 214 are each configured identically to the corresponding components of Embodiment 1.

The output controller 215 of Embodiment 1 may convert a 2D program into a 3D program, or convert a 3D program into a 2D program. However, in Embodiment 2, the transmission device 10a has already performed the conversion of the 2D program into a 3D program or of a 3D program into a 2D program. Accordingly, the output unit 215a does not function to convert a 2D program decoded by the 2D decoder 213 into a 3D program or to convert a 3D program decoded by the 3D decoder 214 into a 2D program. The output unit 215a simply outputs the 2D program received from the 2D decoder 213 and the 3D program received from the 3D decoder 214 to the HDMI transmitter 205a.

The HDMI transmitter 205a of Embodiment 2 transmit the decoded frames to the digital television 30a connected to the HDMI cable 40, similarly to the HDMI transmitter 205 of Embodiment 1. Here, when copied frames have been generated from the original 2D images in order to double the frame rate of the 2D program when transmitting frames, the redundant flag generator 216 applies a redundant flag to the redundant frames not required for display on the digital television 30a.

Specifically, the redundant flag generator 216 uses the 2D flag added to the 3D program to distinguish between redundant frames and other frames. The redundant flag generator 216 assigns a redundant flag with a value of one to redundant frames, and assigns a redundant flag with a value of zero to other frames. The redundant flag is, for example stored in a frame header or the like of a format conforming to the HDMI standard, and transmitted to the digital television 30a.

### <2-5. Digital Television 30a Configuration>

As shown in FIG. 16, the digital television 30a includes an HDMI receiver 301, a video display processor 302a, and a display 303.

The digital television 30a also includes a processor, RAM, ROM, and a hard disk, none of which are diagrammed. The functional blocks of the digital television 30a may be realised as a hardware configuration, or as a computer program stored in ROM or on the hard disk and executed by the processor.

The HDMI receiver 301 and the display 303 are identical to the corresponding components of Embodiment 1.

Upon receiving the output program from the HDMI receiver 301, the video display processor 302a, which has an internal frame buffer similar to the video display processor 302 of Embodiment 1, stores the frames of the output program in the frame buffer.

In Embodiment 2, a redundant flag is stored in the header of each frame. When the redundant flag of a received frame has a value of one, the video display processor 302a deletes the received frame without storing it in the frame buffer, as that frame is a redundant frame not needed for display by the digital television 30a.

### <2-6. BD Recorder 20a and Digital Television 30a Operations>

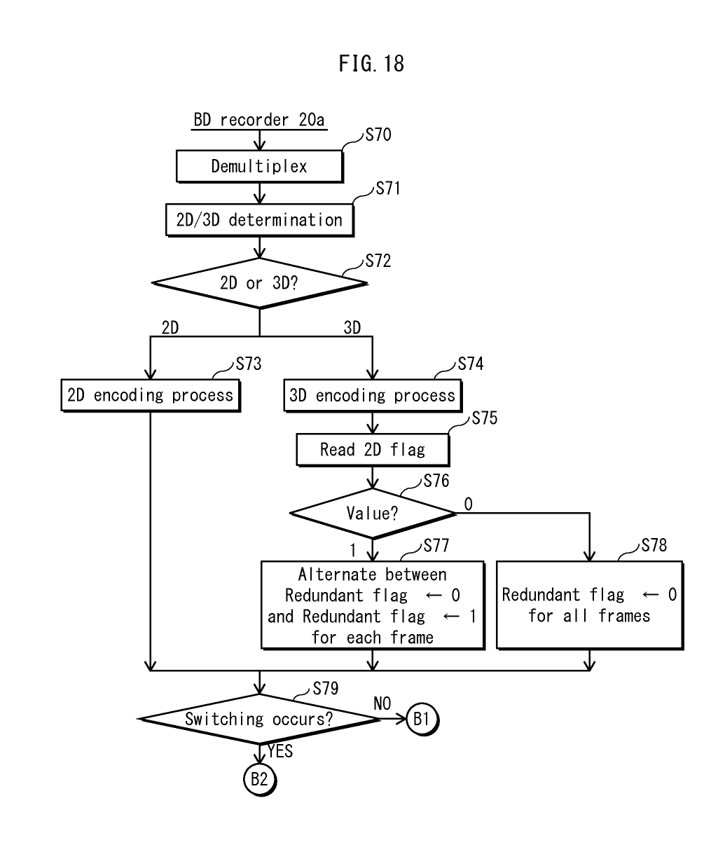

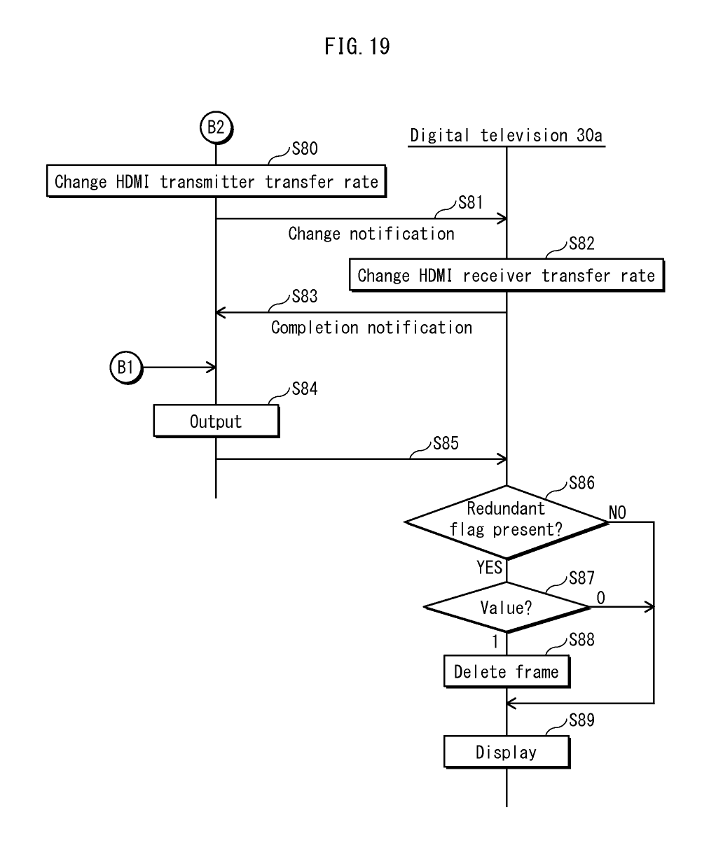

FIGS. 18 and 19 are flowcharts of the operations performed by the BD recorder 20a and the digital television 30a.

The tuner 201 receives the broadcast program and demodulates it into a TS. The demultiplexer 202 demultiplexes the TS (step S70). The demultiplexer 202 sequentially outputs the demultiplexed video streams (i.e., programs) to the decoding processor 204.

The 2D/3D determiner 211 of the decoding processor 204a references the 3D flag to determine whether or not the program subject to processing (also termed a subject program) is a 2D program or a 3D program (step S71). When the 3D flag is set to zero, the subject program is a 2D program. When the 3D flag is set to one, the subject program is a 3D program.

When the subject program is a 2D program (2D in step S72), the 2D decoder 213 performs a decoding process (step S73). Afterward, the process advances to step S79.

When the subject program is a 3D program (3D in step S72), the 3D decoder 214 performs a decoding process (step S74). Upon receiving the decoded subject program via the output unit 215a, the HDMI transmitter 205a reads the value of the 2D flag added to the subject program (step S75).

When the 2D flag has a value of one (1 in step S76), the subject program is an originally 2D program converted into a 3D program with redundant frames. The HDMI transmitter 205a then adds the redundant flag to the frames of the subject program beginning with the first frame, which reads zero, so as to then alternate between values of zero and one (step S77). Afterward, the process advances to step S79.

When the 2D flag has a value of zero (0 in step S76), the subject program is a 3D program without redundant frames. The HDMI transmitter 205a thus adds a redundant flag having a value of zero to all frames of the subject program (step S78).

The HDMI transmitter 205a determines whether or not a change in display mode occurs. A change of display mode occurs when the preceding program is a 2D program and the subject program is a 3D program, and when the preceding program is a 3D program and the subject program is a 2D program.

When there is no change in display mode (NO in step S79), the process advances to step S84.

When there is a change in display mode (YES in step S79), the HDMI transmitter 205a performs a communication mode reset to change the transfer rate (step S80). The HDMI transmitter 205a then transmits a transfer rate change notification to the HDMI receiver 301 of the digital television 30a (step S81).

Upon receiving the change notification, the HDMI receiver 301 also performs the communication mode reset to change the transfer rate (step S82). The HDMI receiver 301 then transmits a transfer rate change completion notification to the HDMI transmitter 205a (step S83).

Upon receiving the completion notification, the HDMI transmitter 205a outputs the subject program to the HDMI cable 40 (step S84). The HDMI receiver 301 receives the subject program via the HDMI cable 40 (step S85).

Upon receiving the subject program from the HDMI receiver 301, the video display processor 302a determines whether or not the headers in the frames of the subject program include the redundant flags. When the subject program is a 2D program, the headers in the frames do not include the redundant flags. When the subject program is a 3D program, the headers in the frames include the redundant flags.

When the headers do not include the redundant flags (NO in step S86), the video display processor 302a stores the subject program in the frame buffer.

When the headers include the redundant flags (YES in step S86), the video display processor 302a repeats steps S87 and S88 for each frame of the subject program.

For a redundant flag reading zero, i.e., for a frame that is not redundant, the video display processor 302a stores the frame in the frame buffer. For a redundant flag reading one, i.e., for a frame that is redundant, the video display processor 302a deletes the frame without storing it in the frame buffer (step S88).

The display 303 sequentially displays the frames stored in the frame buffer (step S89).

The specific operations performed by the BD recorder 20a and the digital television 30a upon receiving the TS 2100 described in FIG. 16 are described next.

The TS 2100 includes 3D program 2103 and 3D program 2105, such that the 3D programs are output to the digital television 30a in the stated order. 2D flag 2102 corresponds to 3D program 2103. 2D flag 2102 reads one, and thus 3D program 2103 is a 3D program without parallax generated from a 2D program in order to constrain the occurrence of a change in display mode given the relationship with the preceding program, namely 3D program 2101 (see FIG. 14). 3D program 2103 includes redundant frames. 2D flag 2104 corresponds to 3D program 2105. 2D flag 2104 reads zero, and thus 3D program 2105 does not include redundant frames.

The HDMI transmitter 205a receives the decoded 3D program 2103 from the decoding processor 204a. 2D flag 2102 reads one, and thus the HDMI transmitter 205a assigns redundant flags reading zero and one, in alternation. The 3D program 2103 results as a sequence of images such as interval 421 of output program 2200. The leading frame has a redundant flag 431 reading zero, and the second frame has a redundant flag 432 reading one.

The HDMI transmitter 205a then receives the decoded 3D program 2105 from the decoding processor 204a. 2D flag 2104 reads zero, and thus the HDMI transmitter 205a assigns a redundant flags reading zero. The 3D program 2105 results as a sequence of images such as interval 422 of output program 2200.

The video display processor 302a receives output program 2200 and deletes the frames having a redundant flag reading one. As a result, the display 303 displays display program 2300 as indicated in FIG. 16. Display program 2300 has an interval 441 displayed as a 2D program, at a display frequency of 60 Hz. Another interval 442 is displayed as a 3D program, at a display frequency of 120 Hz.

As such, Embodiment 2 has the transmission device 10a generate 2D flags enabling the receiver to delete redundant frames. Accordingly, the flickering that occurs when a 3D program without parallax is played back can be prevented. Furthermore, the digital television 30a is able to constrain electric power consumption.

### 3. Embodiment 3

An image processing system pertaining to Embodiment 3 is described below, with reference to the accompanying drawings.

### <3.1 System Overview>

The image processing system of Embodiment 3 includes a transmission device 10b, a BD recorder 20b, a digital television 30b, a HDMI cable 40, a remote control 50, and 3D glasses 60.

In Embodiment 3, much like Embodiment 2 described above, the transmission device 10a functions to convert a 2D program into a 3D program or to convert a 3D program into a 2D program in order to constrain changes in transfer rate occurring in the HDMI cable 40 when a priority program is transmitted. The transmission device 10b generates 2D flags, much like transmission device 10a.

Furthermore, in Embodiment 3, and much like in the above-described Embodiment 1, the transmission device 10b references the program information of the broadcast program to determine whether each program (i.e., 2D programs and 3D programs) therein has priority, and generates a priority flag. However, in Embodiment 3, the usage method of the priority flag differs from that of Embodiment 1.

The BD recorder 20b generates redundant flags when transmitting HDMI frames to the digital television 30b, similarly to BD recorder 20a of Embodiment 2. At this point, the BD recorder 20b uses the 2D flags and the priority flags to determine the value of the redundant flags. In Embodiment 3, control is performed so as to display a priority program on the digital television 30b without deleting redundant frames when the program is a 3D program lacking parallax generated from a 2D program with redundant frames.

### <3-2. Transmission Device 10b Configuration>

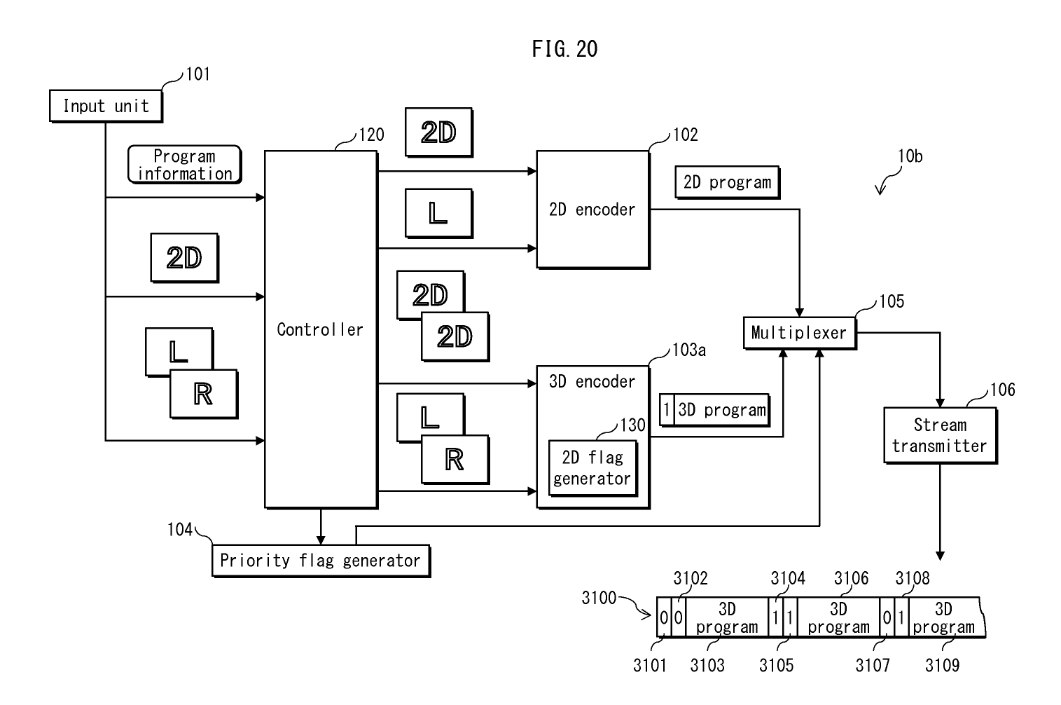

FIG. 20 is a block diagram illustrating the configuration of the transmission device 10b. As shown, the transmission device 10b includes an input unit 101, a controller 120, a 2D encoder 102, a 3D encoder 103a, a priority flag generator 104, a multiplexer 105, and a stream transmitter 106. The 3D encoder 103a also includes a 2D flag generator 130.

Components having the same function as those of the transmission device 10 from Embodiment 1 use the same reference signs thereas. Likewise, components having the same function as those of the transmission device 10a from Embodiment 2 use the same reference signs thereas.

The transmission device 10b also includes a processor, RAM, ROM, and a hard disk, none of which are diagrammed. The functional blocks of the transmission device 10b may be realised as a hardware configuration, or as a computer program stored in ROM or on the hard disk and executed by the processor.

The TS 3100 illustrated in FIG. 20 is a simplified transport stream as transmitted by the stream transmitter 106. A 3D program 3103 is a leading program. The 3D program 3103 is followed by a 3D program 3106, a 3D program 3109, and so on, transmitted in order.

Priority flag 3101 and 2D flag 3102 correspond to 3D program 3103. Priority flag 3101 is set to zero, thus indicating that 3D program 3101 is not a priority program. Given that 2D flag 3102 reads zero, 3D program 31015 is identified as not being a 2D program converted into a 3D program by the controller 120.

Priority flag 3104 and 2D flag 3105 correspond to 3D program 3106. Priority flag 3104 is set to one, thus indicating that 3D program 3106 is a priority program. Given that 2D flag 3105 reads one, 3D program 3106 is identified as having originally been a 2D program, converted into a 3D program by the controller 120.

Priority flag 3107 and 2D flag 3108 correspond to 3D program 3109. Priority flag 3107 is set to zero, thus indicating that 3D program 3106 is not a priority program. Given that 2D flag 3108 reads one, 3D program 3109 is identified as having originally been a 2D program, converted into a 3D program by the controller 120.

### <3-3. Transmission Device 10b Operations>

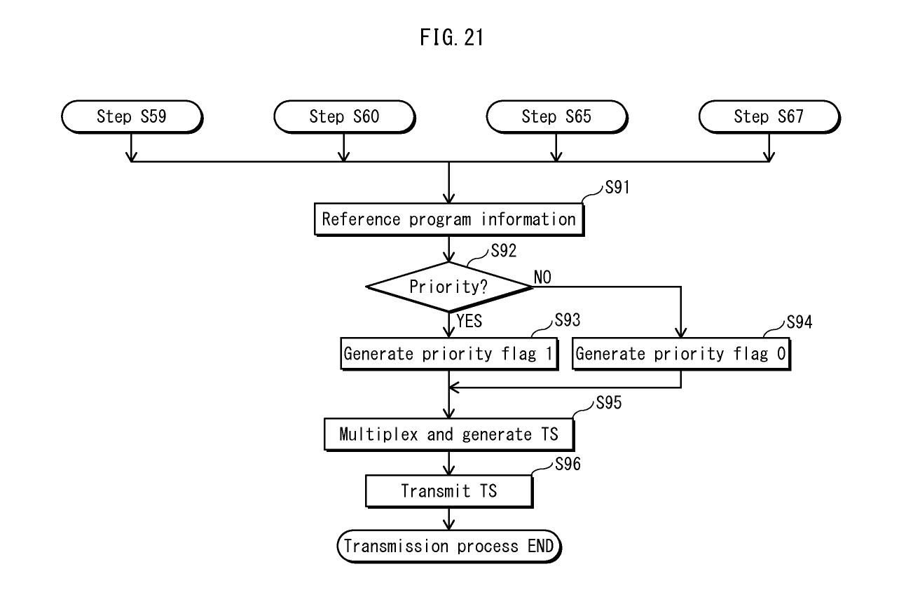

The following describes the operations of the transmission device 10b with reference to the flowchart of FIG. 21.

The transmission device 10b performs the same processing as the transmission device 10a of Embodiment 2 from step S51 of FIG. 15 through steps S59, S60, S65, and S67. Afterward, the process advances to step S91 of FIG. 21.

The priority flag generator 104 references the program information received from the controller 120 (step S91) and determines whether or not the subject program has priority. Here, the priority flag generator 104 is able to identify the subject program using the program ID. The priority flag generator 104 extracts the priority corresponding to the program ID of the subject program from the program information. The priority field reads Priority to indicate that the subject program has priority. The priority field reads Normal to indicate that the subject program does not have priority.

When the subject program has priority (YES in step S92), the priority flag generator 104 generates a priority flag of one (step S93) and outputs the results to the multiplexer 105.

When the subject program does not have priority (NO in step S92), the priority flag generator 104 generates a priority flag of zero (step S93) and outputs the results to the multiplexer 105.

The multiplexer 105 receives the encoded 2D program, the encoded 3D program, the PSI, the audio stream, and other multimedia streams, and performs multiplexing thereon to generate the transport stream (step S95).

The stream transmitter 106 transmits the transport stream generated by the multiplexer 105 on digital broadcast waves (step S96).

### <3-4. BD Recorder 20b Configuration>

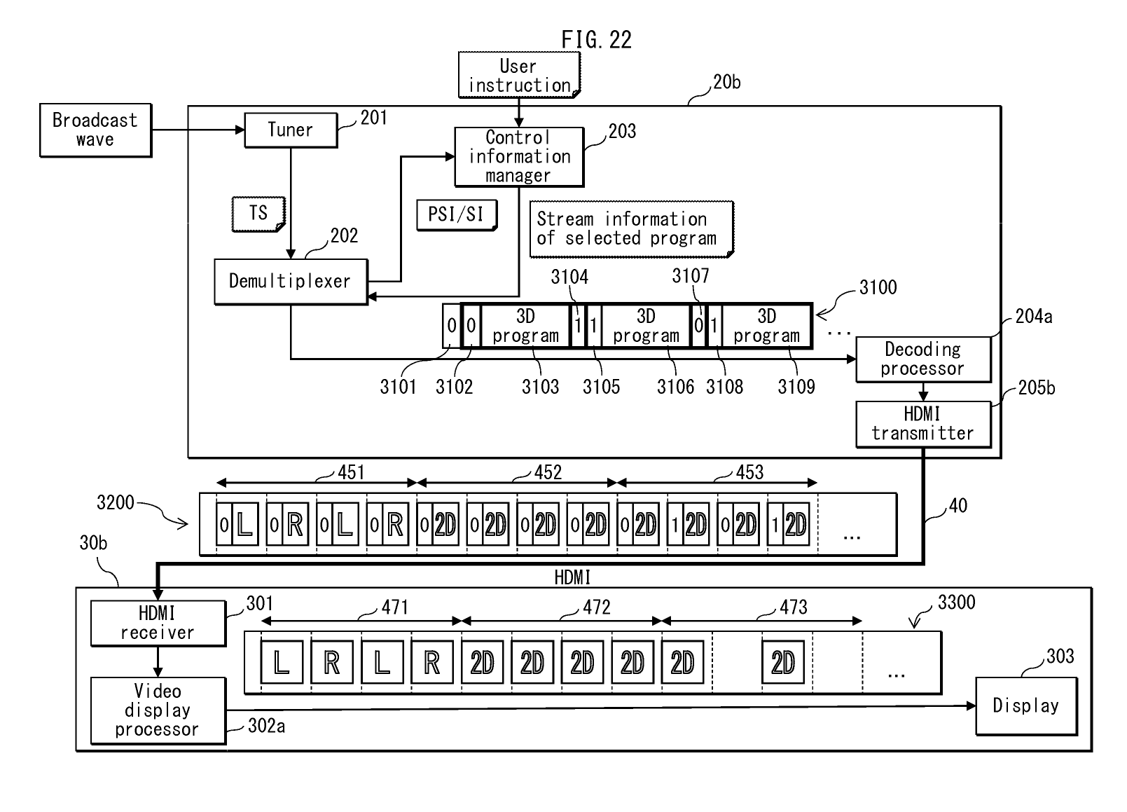

FIG. 22 is a block diagram illustrating the configurations of the BD recorder 20b and the digital television 30b.

As shown, the BD recorder 20b includes a tuner 201, a demultiplexer 202, a control information manager 203, a decoding processor 204a, and an HDMI transmitter 205b.

The BD recorder 20b also includes a processor, RAM, ROM, and a hard disk, none of which are diagrammed. The functional blocks of the BD recorder 20b may be realised as a hardware configuration, or as a computer program stored in ROM or on the hard disk and executed by the processor.

The tuner 201, the demultiplexer 202, and the control information manager 203 are each configured identically to the corresponding components of Embodiment 1. The decoding processor 204a is configured similarly to the corresponding component of Embodiment 2.

The HDMI transmitter 205b includes a redundant flag generator, similar to Embodiment 2. The redundant flag generator of Embodiment 3 uses the priority flags and the 2D flags when adding the redundant flags to the frames of the 3D program.

Specifically, the HDMI transmitter 205b is able use the 2D flag to distinguish between redundant frames and other frames. In addition, the HDMI transmitter 205b uses the priority flag to specify the priority program. When redundant frames are present in a priority program, the HDMI transmitter 205b sets the redundant flags of all frames to zero so as to prevent the redundant frames from being deleted, thus constraining the occurrence of a change in display frequency by the digital television 30b.

### <3-5. Digital Television 30b Configuration>

As shown in FIG. 22, the digital television 30b includes an HDMI receiver 301, a video display processor 302a, and a display 303.

The digital television 30b also includes a processor, RAM, ROM, and a hard disk, none of which are diagrammed. The functional blocks of the digital television 30b may be realised as a hardware configuration, or as a computer program stored in ROM or on the hard disk and executed by the processor.

The HDMI receiver 301 and the display 303 are identical to the corresponding components of Embodiment 1. The video display processor 302a is configured similarly to the corresponding component of Embodiment 2.

### <3-6. BD Recorder 20b and Digital Television 30b Operations>

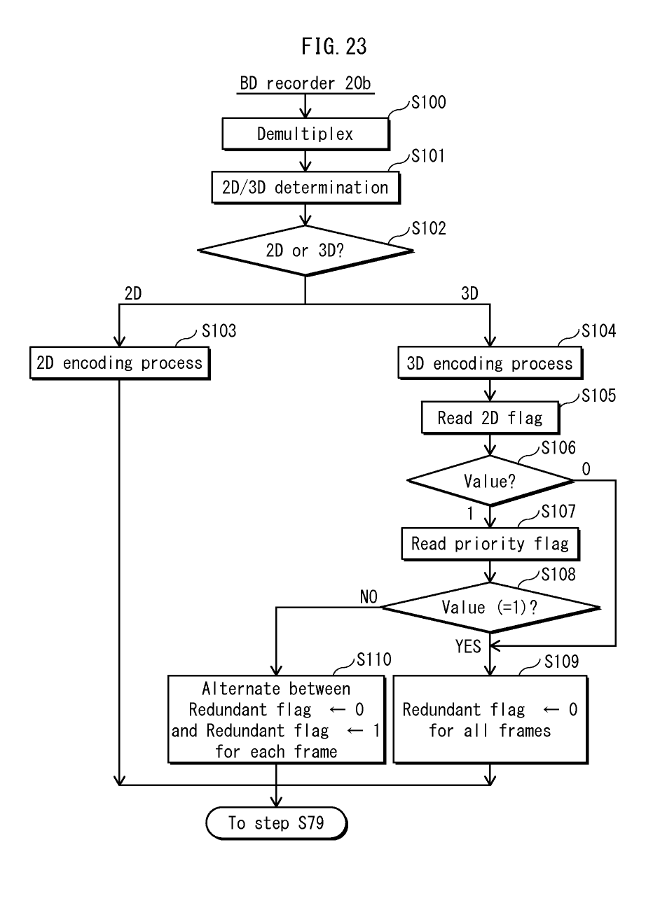

FIG. 23 is a flowchart of the operations performed by the BD recorder 20b and the digital television 30b.

The tuner 201 receives the broadcast program and demodulates it into a TS. The demultiplexer 202 demultiplexes the TS (step S100). The demultiplexer 202 sequentially outputs the demultiplexed video streams (i.e., programs) to the decoding processor 204a.

The 2D/3D determiner 211 of the decoding processor 204a references the 3D flag to determine whether or not the program subject to processing (also termed a subject program) is a 2D program or a 3D program (step S101). When the 3D flag is set to zero, the subject program is a 2D program. When the 3D flag is set to one, the subject program is a 3D program.

When the subject program is a 2D program (2D in step S102), the 2D decoder 213 performs a decoding process (step S103). The process then continues as explained in Embodiment 2, advancing to step S79 of FIG. 18.

When the subject program is a 3D program (3D in step S102), the 3D decoder 214 performs a decoding process (step S104).

Upon receiving the decoded subject program via the output unit 215a, the HDMI transmitter 205b reads the value of the 2D flag added to the subject program (step S105). When the 2D flag has a value of zero (0 in step S106), the subject program is a 3D program without redundant frames. The process thus advances to step S109.

When the 2D flag has a value of one (1 in step S106), the subject program is an originally 2D program converted into a 3D program with redundant frames. Next, the HDMI transmitter 205b reads the value of the priority flag assigned to the subject program (step S107).

When the priority flag has a value of one and the subject program is thus a priority program (YES in step S108), the HDMI transmitter 205b adds a redundant flag having a value of zero to each frame of the subject program (step S109). The process then continues as explained in Embodiment 2, advancing to step S79 of FIG. 18.

When the priority flag reads zero and the subject program thus does not have priority (NO in step S108), the HDMI transmitter 205b adds the redundant flag to the frames of the subject program beginning with the first frame, which reads zero, so as to then alternate between values of zero and one (step S110). The process then continues as explained in Embodiment 2, advancing to step S79 of FIG. 18.

The specific operations performed by the BD recorder 20b and the digital television 30b upon receiving the TS 3100 described in FIG. 22 are described next.

The HDMI transmitter 205b then receives the decoded 3D program 3103 from the decoding processor 204a. 2D flag 3102 reads zero, and thus the HDMI transmitter 205b assigns a redundant flags reading zero. The 3D program 3103 results as a sequence of images such as interval 451 of output program 3200.

The HDMI transmitter 205b then receives the decoded 3D program 3106 from the decoding processor 204a. 2D flag 3105 reads one and the priority flag 3104 reads one, and thus the HDMI transmitter 205b assigns a redundant flag reading zero. The 3D program 3106 results as a sequence of images such as interval 452 of output program 3200.

The HDMI transmitter 205b then receives the decoded 3D program 3109 from the decoding processor 204a. 2D flag 3108 reads one and the priority flag 3107 reads zero, and thus the HDMI transmitter 205b assigns a redundant flags reading zero and one, in alternation. The 3D program 3109 results as a sequence of images such as interval 453 of output program 3200.

The video display processor 302a receives output program 3200 and deletes the frames having a redundant flag reading one. As a result, the display 303 displays display program 3300 as indicated in FIG. 22. Display program 3300 has an interval 471 displayed as a 3D program, at a display frequency of 120 Hz. Another interval 472 is displayed as a 3D program without parallax, at a display frequency of 120 Hz. A further interval 473 is displayed as a 2D program, at a display frequency of 60 Hz.

That is, in Embodiment 3, an interval having priority such as interval 472 does not cause a change in display frequency in the digital television 30b. As such, Embodiment 3 constrains any occurrence of the screen blacking out for a moment when changing the display frequency, so as to perfectly display the priority program.

### 4. Other Variations

Although the image processing system pertaining to the disclosure has been described in the above Embodiments, other variations on the image processing system are also possible, such as those described below. Of course, no limitation is intended to the image processing system of the above-described Embodiments.
(1) In the above-described Embodiments, the broadcast program is transmitted by a digital broadcast wave. However, no such limitation is intended. The broadcast program may also perform transmission via a network such as the Internet, and reception and playback may be performed by a digital television, a BD recorder, a personal computer, or any other device.
(2) In Embodiments 2 and 3, the 2D flag may be stored in Supplemental Enhancement Information (hereinafter, SEI) defined in the H.264 standard, in a UserData unit defined in the MPEG2 standard, in additional information of the TS, or in the program information.
(3) In the above-described Embodiments, the priority flag and the 2D flag are transmitted in the same transport stream as the video streams of the broadcast program. However, no such limitation is intended. The priority flag and the 2D flag may also be transmitted through a separate channel, apart from the transport stream of the broadcast program.
(4) In the above-described Embodiments, the display mode of the priority program is changed so as to match the display mode of a preceding program output immediately before the priority program. However, no such limitation is intended. The display mode of the preceding program may instead be changed to match the display mode of the priority program.

In Embodiment 1, when the receiver changes the display mode, there is a need for the BD recorder to determine, before outputting the preceding program, whether or not the subsequent program to be output immediately after the preceding program is a priority program. When the subsequent program has priority and the display modes of the preceding program and the priority program differ, the BD recorder converts the preceding program into a 3D program or into a 2D program.

In Embodiments 2 and 3, where the transmitter performs the change in display mode, the transmission device references the program information, and when the priority field of the program to be output subsequently after the preceding program is set to Priority, and the display modes of the preceding program and the priority program match, the transmission device converts the preceding program from a 2D program to a 3D program, or from a 3D program to a 2D program. Afterword, the transmission device performs encoding on the preceding program.
(5) The program information 1500 depicted in FIG. 6 is an example, only. For instance, the priority field is not required when the transmission device is able to determine whether or not a program has priority by consulting a program content field.
(6) In the above-described Embodiments, one example defines a commercial as a priority program and a feature as a normal program. However, no such limitation is intended. When a program is intended to be displayed correctly without division by the receiver, any such program may be defined as a priority program.
(7) In the above-described Embodiments, an example is given where a normal television broadcast of the 7:00 news includes a feature and commercials, each defined as one program. However, this is intended as an example only. The program may be defined as content in entirety, or as a plurality of pieces of content broadcast in a given time slot. For example, when 3D programs only have a possibility of being broadcast in the morning, then all content broadcast in the morning may be defined as a program for the purposes of the present disclosure.
(8) In the above-described Embodiments, the priority flag and the 2D flag are assigned in program units only. However, this is intended as an example only. The priority flag and the 2D flag may be assigned to every frame, or to every instance a given set of frames, or to every instance of a playback interval of a given length.
(9) In Embodiment 1, above, an additional view video stream typically has a reduced resolution when a 3D program is encoded, and the receiver typically selects the base view video stream when converting the 3D program into a 2D program.

However, depending on capture conditions (e.g., angles) at the 3D program production stage, the receiver may be unable to use the base view video stream for converting the 3D program into a 2D program and thus use the additional view video stream of reduced images for 2D display.

Also, although the additional view video stream has been reduced, when the values of the horizontal reduction factor 1403 and/or the vertical reduction factor 1404 of the additional information 1400 are sufficiently large, the effect of reduction is negligible. Thus, the transmission device 10 may set the 2D usability flag 1405 of in additional information 1400 of the additional view stream to TRUE.

In the above-described Embodiments, the BD recorder 20 uses the base view video stream for 2D display when the 2D usability flag 1405 of in additional information 1400 of the additional view stream is set to FALSE. The BD recorder 20 may use either of the base view video stream and the additional view video stream for 2D display when the 2D usability flag 1405 of in additional information 1400 of the additional view stream is set to TRUE.

The BD recorder 20 need not necessarily use the 2D usability flag 1405 of the additional information 1400 to determine whether or not to use the additional view video stream for 2D display. For instance, when images selected using the 2D usability flag 1405 in the 2D display mode alternate between left-view and right-view images over a short interval, the alternation may cause shaking on the screen, which is not beneficial.

Once 2D display using the additional view video stream has begun, display may continue to use the additional view video stream independently of the value of the 2D usability flag 1405 in the additional information 1400.

Similarly, once 2D display using the base view video stream has begun, display may continue to use the base view video stream independently of the value of the 2D usability flag 1405 in the additional information 1400.
(10) In Embodiment 1, described above, the BD recorder 20 uses the additional information 1400 to select one of the base view video stream and the additional view video stream when performing 2D display of a 3D program.

The following process involving the additional information 1400 of the BD recorder 20 may also be used.

For example, when the digital television 30 does not have a 3D display function, the BD recorder 20 may use the additional information 1400 assigned to a received 3D program to determine whether to output left-view images or right-view images to the digital television 30.

Also, when the digital television 30 does have a 3D display function but the user has disabled the 3D display function, the BD recorder 20 may use the additional information 1400 assigned to a received 3D program to determine whether to output left-view images or right-view images to the digital television 30.

As such, the BD recorder 20 may use the additional information 1400 to select either of the right-view images and the left-view images.
(11) In the above-described Embodiments, the BD recorder and the digital television are connected by an HDMI cable. However, this is only intended as an example. The BD recorder and the digital television may also be connected wirelessly, using a digital signal transmission method that conforms to the HDMI standard.
(12) In the above-described Embodiments, the image processing system includes a transmission device, a BD recorder, and a digital television.

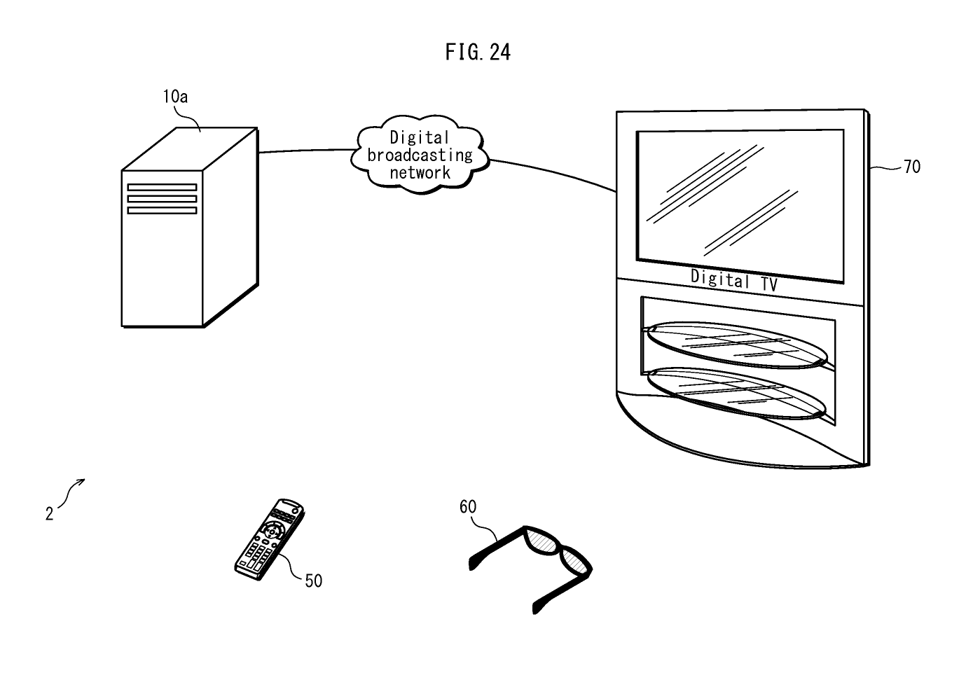

The following describes a variant image processing system 2 with reference to FIG. 24. The image processing system 2 includes a transmission device 10a, a digital television 70, a remote control 50, and 3D glasses 60.

The transmission device 10a is configured similarly to that of Embodiment 2 (see FIG. 14). The digital television 70 includes the tuner 201, the demultiplexer 202, the control information manager 203, the decoding processor 204a, the video display processor 302a, and the display 303, each indicated in FIG. 16. That is, the digital television 70 combines a reception device and a display device into a single device. The image processing system 2 does not perform any HDMI communication mode reset as no HDMI cable is used to transport the programs.

However, when 2D programs and 3D programs are combined, the decoding processor 204a of the digital television 70 switches between decoding methods. Switching between decoding methods means that the decoding process is interrupted, and that a delay may occur in the display of programs on the display 303.

The transmission device 10a may convert a 2D program into a 3D program, or convert a 3D program into a 2D program, much like Embodiment 2. Accordingly, a change in decoding method is prevented from occurring between a priority program and a preceding program output immediately before the priority program, thereby avoiding any delay in the display of the priority programs by the display 303.
(13) In the above-described Embodiments, H.264 MVC is given as an example of a 3D coding method. However, no such limitation is intended. The transmission device may also use a 3D coding method in the Side-by-Side method, where left-view images and right-view images are aligned horizontally, the Top and Bottom methods where left-view images and right-view images are aligned vertically, in the Line Alternative method where the lines within a single picture alternate between left-view images and right-view images, and so on. In such cases, the decoding method used by the receiver may be any method corresponding to the coding method used by the transmission device.
(14) The transmission process, reception process, and display process described in the above Embodiments may be realised as a control program written in program codes of a machine language or a high-level language to be executed by the processor of the transmission device 10, the BD recorder 20, and the digital television 30, or by various circuits connected thereto, and the control program may be written onto a recording medium and delivered or distributed through various communications channels. The recording medium may be an IC card, a hard disk, an optical disc, a floppy disk, ROM, flash memory, and so on. The control program that is delivered and distributed is used by being stored in processor-readable memory, and the various functions described in the above Embodiments are realised by the processor executing the control program. The processor may directly execute the control program, or may execute a compiled or interpreted program based thereon.
(15) The various functional components of the above-described Embodiments (i.e., the input unit 101, the 2D encoder 102, the 3D encoder 103, the priority flag generator 104, the multiplexer 105, the stream transmitter 106, the tuner 201, the demultiplexer 202, the control information manager 203, the decoding processor 204, the HDMI transmitter 205, the HDMI receiver 301, the video display processor 302, and the display 303) may be realised as circuits executing the corresponding functions, or as one or more processors executing a program. The transmission device, the BD recorder, and the digital television of Embodiments 1-3 may also be realised as an IC, an LSI, or another integrated circuit package. Such a package is provided as embedded within each device, such that each device is able to execute the appropriate functions.
(16) The above-described Embodiments and Variations may be freely combined.

### 5. Supplement

Various aspects and variations of the image processing system, the transmission device, and the reception device are described below, along with effects thereof.
(a) An image processing system comprises a transmission device and a reception device, wherein the transmission device includes: a 3D encoder encoding 3D images input thereto to generate a 3D program; a stream generator generating a video stream made up of a plurality of programs, including the 3D program generated by the 3D encoder; a stream transmitter transmitting the video stream; and an information transmitter transmitting information for specifying a priority program among the programs in the video stream; and the reception device includes: an information receiver receiving the information; a stream receiver receiving the video stream; and a decoding processor decoding the video stream, specifying the priority program by using the information, and performing control such that the priority program is output to a channel used for connecting to a display device at a priority program transfer rate equal to a preceding program transfer rate used for a preceding program output immediately before the priority program.

According to this configuration, the priority program is output at the same transfer rate as the preceding program, thus removing any need for a communication mode reset between the reception device and the display device. Thus, the display device is able to normally display the priority program.
(b) Also, the transmission device may further include: an input unit receiving a plurality of programs, each made up of 2D source images or of 3D source images; and a 2D encoder encoding 2D images input thereto with a 2D encoding method to generate a 2D program, the 3D encoder encodes the 3D images input thereto with a 3D encoding method, the stream generator generates the video stream to also include the 2D program generated by the 2D encoder, and the decoding processor equalizes the priority program transfer rate and the preceding program transfer rate by performing, on one of the priority program and the preceding program, a conversion of decoded 2D images into 3D images by doubling data or a conversion of decoded 3D images to 2D images by halving data.

According to this configuration, the priority program is output at the same transfer rate as the preceding program despite a 2D program and a 3D program being combined, thus removing any need for a communication mode reset between the reception device and the display device. Thus, the display device is able to normally display the priority program.
(c) A transmission device comprises: a 3D encoder encoding 3D images input thereto to generate a 3D program; a stream generator generating a video stream made up of a plurality of programs, including the 3D program generated by the 3D encoder; a stream transmitter transmitting the video stream; and an information transmitter transmitting information for specifying a priority program among the programs in the video stream, the priority program being intended for output to a channel used for connecting a reception device corresponding to the transmission device to a display device at a priority program transfer rate equal to a preceding program transfer rate used for a preceding program output immediately before the priority program.

According to this configuration, the priority program is output at the same transfer rate as the preceding program by a reception device corresponding to the transmission device, thus removing any need for a communication mode reset between the reception device and the display device. Thus, the display device is able to normally display the priority program.
(d) Also, the 3D program generated by the 3D encoder includes a left-view video stream and a right-view video stream, one of the left-view video stream and the right-view video stream being a base view video stream and the other being an additional view video stream, the additional view video stream having been generated with reference to the base view video stream, and the 3D encoder includes: an additional information generator generating additional information indicating, in accordance with a reduction factor applied to 3D source images upon generation of the additional view video stream, whether or not the additional view video stream is used when the reception device converts the 3D images into 2D images; and an output unit outputting the additional information in association with the additional view video stream information.

According to this configuration, the reception device selects appropriate images by using the additional information when converting 3D images into 2D images.
(e) A transmission device comprises: a 3D encoder encoding 3D images input thereto to generate a 3D program; a stream generator generating a video stream made up of a plurality of programs, including the 3D program generated by the 3D encoder; and stream transmitter transmitting the video stream, wherein the 3D program generated by the 3D encoder includes a left-view video stream and a right-view video stream, one of the left-view video stream and the right-view video stream being a base view video stream and the other being an additional view video stream, the additional view video stream having been generated with reference to the base view video stream, and the 3D encoder includes: an additional information generator generating additional information indicating, in accordance with a reduction factor applied to 3D source images upon generation of the additional view video stream, whether or not the additional view video stream is used when the reception device converts the 3D images into 2D images; and an output unit outputting the additional information in association with the additional view video stream information.

According to this configuration, the reception device selects appropriate images by using the additional information when converting 3D images into 2D images.
(f) A transmission device comprises: an input unit receiving a plurality of programs, each made up of 2D source images or 3D source images; a 2D encoder encoding 2D images input thereto with a 2D encoding method to generate a 2D program, a 3D encoder encoding 3D images input thereto with a 3D encoding method to generate a 3D program, a controller performing control such that, when the input unit receives a priority program, the priority program is encoded using the same encoding method as a preceding program transmitted immediately before the priority program; stream generator generating a video stream that at least includes the 2D program generated by the 2D encoder or the 3D program generated by the 3D encoder; and a transmission unit transmitting the video stream.

According to this configuration, the priority program is output at the same transfer rate as the preceding program despite a 2D program and a 3D program being combined, thus removing any need for a communication mode reset between the reception device and the display device. Thus, the display device is able to normally display the priority program.
(g) Also, when the priority program is made up of the 2D source images and the preceding program is made up of the 3D source images: the input unit inputs the 3D source images making up the preceding program to the 3D encoder as the 3D images; the controller generates new 3D images from the 2D source images making up the priority program, and inputs the new 3D images to the 3D encoder; and the stream generator generates the video stream so as to include the priority program as the 3D program generated by the 3D encoder and the preceding program, which is another 3D program.

According to this configuration, no change in display mode occurs in the receiver as the priority program that is originally in 2D is converted into a 3D program to match the display mode of the preceding program. Accordingly, a state is avoided in which the first portion of a priority program, such as a commercial, is not displayed.
(h) Further, the controller generates 3D images without parallax by duplicating the 2D source images making up the priority program and inputs the 3D images without parallax to the 3D encoder, and the transmission device further includes an information transmitter transmitting information for specifying a 3D program without parallax generated by the 3D encoder.

A 3D program without parallax includes redundant frames that are not necessary for playback. As such, displaying a 3D program without parallax poses a problem of increased electric power consumption by the display device. According to the above configuration, the reception device receives information from the transmission device for specifying a 3D program without parallax, thus enabling an instruction for deleting the redundant frames to be made to the display device. Accordingly, the increased electric power consumption by the display device is constrained.
(i) In addition, the information transmitter transmits the information to further specify the priority program, among the programs in the video stream, as being intended for display on a display device connected to a reception device corresponding to the transmission device at a priority program display frequency equal to a preceding program display frequency used immediately previously.

When the display device switches between the 2D display mode and the 3D display mode, the display frequency must also be changed. The change in display frequency may also cause the screen to be blacked out. According to the above configuration, the reception device receiving the information specifying the priority program from the transmission device is able to make an instruction to the display device such that the priority program is displayed at the same display frequency as the preceding program, thus preventing a change in display frequency by the display device and constraining the screen from being blacked out.
(j) Furthermore, when the priority program is made up of the 2D source images and the preceding program is made up of the 3D source images: the input unit inputs the 2D source images making up the priority program to the 2D encoder as the 2D images; the controller generates new 2D images from the 3D source images making up the preceding program, and inputs the new 2D images to the 2D encoder; and the video stream generator generates the video stream so as to include the priority program as the 2D program generated by the 2D encoder and the preceding program, which is another 2D program.

According to this configuration, no change in display mode occurs in the receiver as the preceding program that is originally in 3D is converted into a 2D program to match the display mode of the priority program. Accordingly, a state is avoided in which the first portion of a priority program, such as a commercial, is not displayed.
(k) Additionally, when the priority program is made up of the 3D source images and the preceding program is made up of the 2D source images: the input unit inputs the 2D source images making up the preceding program to the 2D encoder as the 2D images; the controller generates new 2D images from the 3D source images making up the priority program, and inputs the new 2D images to the 2D encoder; and the video stream generator generates the video stream so as to include the priority program as the 2D program generated by the 2D encoder and the preceding program, which is another 2D program.

According to this configuration, no change in display mode occurs in the receiver as the priority program that is originally in 3D is converted into a 2D program to match the display mode of the preceding program. Accordingly, a state is avoided in which the first portion of a priority program, such as a commercial, is not displayed.
(l) Further still, when the priority program is made up of the 3D source images and the preceding program is made up of the 2D source images: the input unit inputs the 3D source images making up the priority program to the 3D encoder as the 3D images; the controller generates new 3D images from the 2D source images making up the preceding program, and inputs the new 3D images to the 3D encoder; and the video stream generator generates the video stream so as to include the priority program as the 3D program generated by the 3D encoder and the preceding program, which is another 3D program.

According to this configuration, no change in display mode occurs in the receiver as the preceding program that is originally in 2D is converted into a 3D program to match the display mode of the priority program. Accordingly, a state is avoided in which the first portion of a priority program, such as a commercial, is not displayed.
(m) Yet still, the controller generates 3D images without parallax by duplicating the 2D source images making up the preceding program and inputs the 3D images without parallax to the 3D encoder, and the transmission device further includes an information transmitter transmitting information for specifying a 3D program without parallax generated by the 3D encoder.

A 3D program without parallax includes redundant frames that are not necessary for playback. As such, displaying a 3D program without parallax poses a problem of increased electric power consumption by the display device. According to the above configuration, the reception device receives information from the transmission device for specifying a 3D program without parallax, thus enabling an instruction for deleting the redundant frames to be made to the display device. Accordingly, the increased electric power consumption by the display device is constrained.
(n) Yet further, the information transmitter transmits the information to further specify the priority program, among the programs in the video stream, as being intended for display on a display device connected to a reception device corresponding to the transmission device at a priority program display frequency equal to a preceding program display frequency used immediately previously.

When the display device switches between the 2D display mode and the 3D display mode, the display frequency must also be changed. The change in display frequency may also cause the screen to be blacked out. According to the above configuration, the reception device receiving the information specifying the priority program from the transmission device is able to make an instruction to the display device such that the priority program is displayed at the same display frequency as the preceding program, thus preventing a change in display frequency by the display device and constraining the screen from being blacked out.
(o) A reception device comprises: a stream receiver receiving a video stream made up of a plurality of programs, including a 3D program encoded using a 3D encoding method; an information receiver receiving information for specifying a priority program among the programs in the video stream; and a decoding processor decoding the video stream, using the information to specify the priority program, and performing control such that the priority program is output to a channel used for connecting to a display device at a priority program transfer rate equal to a preceding program transfer rate used by a preceding program output immediately before the priority program.

According to this configuration, the priority program is output at the same transfer rate as the preceding program, thus removing any need for a communication mode reset between the reception device and the display device. Thus, the display device is able to normally display the priority program.
(p) Also, the video stream further includes a 2D program encoded using a 2D encoding method, and the decoding processor equalizes the priority program transfer rate and the preceding program transfer rate by performing, on one of the priority program and the preceding program, a conversion of decoded 2D images into 3D images by doubling data or a conversion of decoded 3D images to 2D images by halving data.

According to this configuration, the priority program is output at the same transfer rate as the preceding program despite a 2D program and a 3D program being combined, thus removing any need for a communication mode reset between the reception device and the display device. Thus, the display device is able to normally display the priority program.
(q) Still, when the priority program is the 2D program and the preceding program is the 3D program, the decoding processor generates 3D images without parallax by duplicating 2D images obtained upon decoding the priority program, and outputs 3D images obtained upon decoding the preceding program and the 3D images without parallax generated by duplication.

According to this configuration, no change in display mode occurs in the display device as the priority program that is originally in 2D is converted into a 3D program to match the display mode of the preceding program. Accordingly, a state is avoided in which the first portion of a priority program, such as a commercial, is not displayed.
(r) Further, an HDMI transmitter transmitting the 2D images and the 3D images obtained upon decoding to the display device, using a communication method conforming to a High-Definition Multimedia Interface (HDMI) standard, wherein the reception device and the display device are connected via a channel conforming to the HDMI standard, and when transmitting the 3D images without parallax, the HDMI transmitter adds a redundant flag indicating that the 3D images are without parallax.

A 3D program without parallax includes redundant frames that are not necessary for playback. As such, displaying a 3D program without parallax poses a problem of increased electric power consumption by the display device. The reception device thus enables the display device to delete the redundant frames by transmitting a redundant flag to the display device in a header or the like of the redundant frames. Accordingly, the increased electric power consumption by the display device is constrained.
(s) In addition, when the priority program is the 2D program and the preceding program is the 3D program, the decoding processor decodes the preceding program and selects one of left-view images and right-view images for output, and outputs 2D images obtained upon decoding the priority program.

According to this configuration, no change in display mode occurs in the display device as the preceding program that is originally in 3D is converted into a 2D program to match the display mode of the priority program. Accordingly, a state is avoided in which the first portion of a priority program, such as a commercial, is not displayed.
(t) Further still, the 3D program includes a left-view video stream and a right-view video stream, one of the left-view video stream and the right-view video stream being a base view video stream and the other being an additional view video stream, the additional view video stream having been generated with reference to the base view video stream, the additional view video stream has additional information indicating whether or not the additional view video stream is usable when the reception device converts the 3D images into the 2D images, according to whether or not reduction has been applied to 3D source images to generate the additional view video stream, and the decoding processor uses the additional information to specify which of the left-view images and the right-view images, obtained upon decoding the preceding program, is selected.

When 3D source images are being reduced during a additional view video stream generation, using the additional view video stream images in the 2D display mode is likely to cause image degradation and discomfort for the viewer. Thus, according to the above configuration, the reception device is able to select appropriate images using the additional information when converting a preceding program that is a 3D program into a 2D program to match the display mode of a priority program.
(u) Additionally, when the preceding program is the 2D program and the priority program is the 3D program, the decoding processor outputs 2D images obtained upon decoding the preceding program, and decodes the priority program and selects one of left-view images and right-view images for output.

According to this configuration, no change in display mode occurs in the display device as the priority program that is originally in 3D is converted into a 2D program to match the display mode of the preceding program. Accordingly, a state is avoided in which the first portion of a priority program, such as a commercial, is not displayed.
(v) In further addition, the 3D program includes a left-view video stream and a right-view video stream, one of the left-view video stream and the right-view video stream being a base view video stream and the other being an additional view video stream, the additional view video stream having been generated with reference to the base view video stream, the additional view video stream has additional information indicating whether or not the additional view video stream is usable when the reception device converts the 3D images into the 2D images, according to whether or not reduction has been applied to 3D source images to generate the additional view video stream, and the decoding processor uses the additional information to specify which of the left-view images and the right-view images, obtained upon decoding the priority program, is selected.

When 3D source images are being reduced during a additional view video stream generation, using the additional view video stream images in the 2D display mode is likely to cause image degradation and discomfort for the viewer. Thus, according to the above configuration, the reception device is able to select appropriate images using the additional information when converting a priority program that is a 3D program into a 2D program to match the display mode of a preceding program.
(w) Yet further, when the priority program is the 3D program and the preceding program is the 2D program, the decoding processor generates 3D images without parallax by duplicating 2D images obtained upon decoding the preceding program, and outputs 3D images obtained upon decoding the priority program and the 3D images without parallax generated by duplication.

According to this configuration, no change in display mode occurs in the display device as the preceding program that is originally in 2D is converted into a 3D program to match the display mode of the priority program. Accordingly, a state is avoided in which the first portion of a priority program, such as a commercial, is not displayed.
(x) In further addition, an HDMI transmitter transmitting the 2D images and the 3D images obtained upon decoding to a display device, using a communication method conforming to an HDMI standard, wherein the reception device and the display device are connected via a channel conforming to the HDMI standard, and when transmitting the 3D images without parallax, the HDMI transmitter adds a redundant flag indicating that the 3D images are without parallax.

A 3D program without parallax includes redundant frames that are not necessary for playback. As such, displaying a 3D program without parallax poses a problem of increased electric power consumption by the display device. The reception device thus enables the display device to delete the redundant frames by, for instance, transmitting a redundant flag to the display device in a header or the like of the redundant frames. Accordingly, the increased electric power consumption by the display device is constrained.
(y) A reception device, comprising: a stream receiver receiving a video stream made up of a plurality of programs, including a 2D program encoded using a 2D encoding method and a 3D program encoded using a 3D encoding method; an information receiver receiving information for specifying a 3D program without parallax; a decoding processor decoding the video stream received by the stream receiver; and an HDMI transmitter transmitting 2D images and 3D images obtained upon decoding to a display device, using a communication method conforming to an HDMI standard, wherein when transmitting 3D images without parallax, the HDMI transmitter adds a redundant flag indicating that the 3D images are without parallax.

A 3D program without parallax includes redundant frames that are not necessary for playback. As such, displaying a 3D program without parallax poses a problem of increased electric power consumption by the display device. The reception device thus enables the display device to delete the redundant frames by, for instance, transmitting a redundant flag to the display device in a header or the like of the redundant frames. Accordingly, the increased electric power consumption by the display device is constrained.
(z) Also, the information receiver also receives information further specifying the priority program, among the programs in the video stream, as being intended for display on the display device connected to the reception device corresponding to a transmission device at a priority program display frequency equal to a preceding program display frequency used immediately previously, and the HDMI transmitter performs control such that the redundant flag is added to the 3D images when the priority program includes the 3D images without parallax.

When the display device switches between the 2D display mode and the 3D display mode, the display frequency must also be changed. The change in display frequency may also cause the screen to be blacked out. Thus, the above-described reception device constrains the processing applied to adding the redundant flag to the 3D images, such that no display frequency change occurs in the display device and the screen is constrained from blacking out.
(A) A reception device, comprising: a stream receiver receiving a video stream encoded using a 3D encoding method; a 3D decoder decoding the video stream; and an output controller converting 3D images obtained upon decoding into 2D images for output, wherein the video stream includes a left-view video stream and a right-view video stream, one of the left-view video stream and the right-view video stream being a base view video stream and the other being an additional view video stream, the additional view video stream having been generated with reference to the base view video stream, the additional view video stream includes additional information indicating, in accordance with a reduction factor applied to 3D source images upon generation of the additional view video stream, whether or not the additional view video stream is used when the reception device converts the 3D images into 2D images; and the output controller uses the additional information to determine whether or not the additional view video stream is used when converting the 3D images into the 2D images.

When 3D source images are being reduced during a additional view video stream generation, using the additional view video stream images in the 2D display mode is likely to cause image degradation and discomfort for the viewer. Thus, according to the above configuration, the reception device is able to select appropriate images using the additional information when converting 3D images into 2D images.

### INDUSTRIAL APPLICABILITY

The image processing system pertaining to an aspect of the disclosure is applicable to the industries of manufacturing and selling transmission devices, BD recorders, digital televisions, and the like. The image processing system is also applicable to use as technology enabling a priority program to be displayed normally on a digital television despite 2D and 3D programs being combined.

### LIST OF REFERENCE SIGNS

1, 2 Image processing system
10, 10a, 10b Transmission device
20,20a, 20b BD recorder
30, 30a, 30b, 70 Digital television
40 HDMI cable
50 Remote control
60 3D glasses
101 Input unit
102 2D encoder
103, 103a 3D encoder
104 Priority flag generator
105 Multiplexer
106 Stream transmitter
120 Controller
130 2D flag generator
201 Tuner
202 Demultiplexer
203 Control information manager
204, 204a Decoding processor
205, 205a, 205b HDMI transmitter
211 2D/3D determiner
212 Switcher
213 2D decoder
214 3D decoder
215 Output controller
215a Output unit
216 Redundant flag generator
301 HDMI receiver
302, 302a Video display processor
303 Display

1-31. (canceled)

32. An image processing system comprising a transmission device and a reception device, wherein
the transmission device includes:
a 3D encoder encoding 3D images input thereto to generate a 3D program;
a stream generator generating a video stream made up of a plurality of programs, including the 3D program generated by the 3D encoder;
a stream transmitter transmitting the video stream; and
an information transmitter transmitting information for specifying a priority program among the programs in the video stream; and
the reception device includes:
an information receiver receiving the information;
a stream receiver receiving the video stream; and
a decoding processor decoding the video stream, specifying the priority program by using the information, and performing control such that the priority program is output to a channel used for connecting to a display device at a priority program transfer rate equal to a preceding program transfer rate used for a preceding program output immediately before the priority program.

33. The image processing system of claim 32, wherein
the transmission device further includes:
an input unit receiving a plurality of programs, each made up of 2D source images or of 3D source images; and
a 2D encoder encoding 2D images input thereto with a 2D encoding method to generate a 2D program,
the 3D encoder encodes the 3D images input thereto with a 3D encoding method,
the stream generator generates the video stream to also include the 2D program generated by the 2D encoder, and
the decoding processor equalizes the priority program transfer rate and the preceding program transfer rate by performing, on one of the priority program and the preceding program, a conversion of decoded 2D images into 3D images by doubling data or a conversion of decoded 3D images to 2D images by halving data.

34. A transmission device, comprising:
a 3D encoder encoding 3D images input thereto to generate a 3D program;
a stream generator generating a video stream made up of a plurality of programs, including the 3D program generated by the 3D encoder;
a stream transmitter transmitting the video stream; and
an information transmitter transmitting information for specifying a priority program among the programs in the video stream, the priority program being intended for output to a channel used for connecting a reception device corresponding to the transmission device to a display device at a priority program transfer rate equal to a preceding program transfer rate used for a preceding program output immediately before the priority program.

35. The transmission device of claim 34, wherein
the 3D program generated by the 3D encoder includes a left-view video stream and a right-view video stream, one of the left-view video stream and the right-view video stream being a base view video stream and the other being an additional view video stream, the additional view video stream having been generated with reference to the base view video stream, and
the 3D encoder includes:
an additional information generator generating additional information indicating, in accordance with a reduction factor applied to 3D source images upon generation of the additional view video stream, whether the additional view video stream is usable when the reception device converts the 3D images into 2D images; and
an output unit outputting the additional information in association with the additional view video stream information.

36. A transmission device, comprising:
a 3D encoder encoding 3D images input thereto to generate a 3D program;
a stream generator generating a video stream made up of a plurality of programs, including the 3D program generated by the 3D encoder; and
a stream transmitter transmitting the video stream, wherein
the 3D program generated by the 3D encoder includes a left-view video stream and a right-view video stream, one of the left-view video stream and the right-view video stream being a base view video stream and the other being an additional view video stream, the additional view video stream having been generated with reference to the base view video stream, and
the 3D encoder includes:
an additional information generator generating additional information indicating, in accordance with a reduction factor applied to 3D source images upon generation of the additional view video stream, whether the additional view video stream is usable when the reception device converts the 3D images into 2D images; and
an output unit outputting the additional information in association with the additional view video stream information.

37. A transmission device, comprising:
an input unit receiving a plurality of programs, each made up of 2D source images or 3D source images;
a 2D encoder encoding 2D images input thereto with a 2D encoding method to generate a 2D program,
a 3D encoder encoding 3D images input thereto with a 3D encoding method to generate a 3D program,
a controller performing control such that, when the input unit receives a priority program, the priority program is encoded using the same encoding method as a preceding program transmitted immediately before the priority program;
a stream generator generating a video stream that at least includes the 2D program generated by the 2D encoder or the 3D program generated by the 3D encoder; and
a transmission unit transmitting the video stream.

38. The transmission device of claim 37, wherein
when the priority program is made up of the 2D source images and the preceding program is made up of the 3D source images:
the input unit inputs the 3D source images making up the preceding program to the 3D encoder as the 3D images;
the controller generates new 3D images from the 2D source images making up the priority program, and inputs the new 3D images to the 3D encoder; and
the stream generator generates the video stream so as to include the priority program as the 3D program generated by the 3D encoder and the preceding program, which is another 3D program.

39. The transmission device of claim 38, wherein
the controller generates 3D images without parallax by duplicating the 2D source images making up the priority program and inputs the 3D images without parallax to the 3D encoder, and
the transmission device further includes an information transmitter transmitting information for specifying a 3D program without parallax generated by the 3D encoder.

40. The transmission device of claim 39, wherein
the information transmitter transmits the information to further specify the priority program, among the programs in the video stream, as being intended for display on a display device connected to a reception device corresponding to the transmission device at a priority program display frequency equal to a preceding program display frequency used immediately previously.

41. The transmission device of claim 37, wherein
when the priority program is made up of the 2D source images and the preceding program is made up of the 3D source images:
the input unit inputs the 2D source images making up the priority program to the 2D encoder as the 2D images;
the controller generates new 2D images from the 3D source images making up the preceding program, and inputs the new 2D images to the 2D encoder; and
the video stream generator generates the video stream so as to include the priority program as the 2D program generated by the 2D encoder and the preceding program, which is another 2D program.

42. The transmission device of claim 37, wherein
when the priority program is made up of the 3D source images and the preceding program is made up of the 2D source images:
the input unit inputs the 2D source images making up the preceding program to the 2D encoder as the 2D images;
the controller generates new 2D images from the 3D source images making up the priority program, and inputs the new 2D images to the 2D encoder; and
the video stream generator generates the video stream so as to include the priority program as the 2D program generated by the 2D encoder and the preceding program, which is another 2D program.

43. The transmission device of claim 37, wherein
when the priority program is made up of the 3D source images and the preceding program is made up of the 2D source images:
the input unit inputs the 3D source images making up the priority program to the 3D encoder as the 3D images;
the controller generates new 3D images from the 2D source images making up the preceding program, and inputs the new 3D images to the 3D encoder; and
the video stream generator generates the video stream so as to include the priority program as the 3D program generated by the 3D encoder and the preceding program, which is another 3D program.

44. The transmission device of claim 43, wherein
the controller generates 3D images without parallax by duplicating the 2D source images making up the preceding program and inputs the 3D images without parallax to the 3D encoder, and
the transmission device further includes an information transmitter transmitting information for specifying a 3D program without parallax generated by the 3D encoder.

45. The transmission device of claim 44, wherein
the information transmitter transmits the information to further specify the priority program, among the programs in the video stream, as being intended for display on a display device connected to a reception device corresponding to the transmission device at a priority program display frequency equal to a preceding program display frequency used immediately previously.

46. A reception device, comprising:
a stream receiver receiving a video stream made up of a plurality of programs, including a 3D program encoded using a 3D encoding method;
an information receiver receiving information for specifying a priority program among the programs in the video stream; and
a decoding processor decoding the video stream, using the information to specify the priority program, and performing control such that the priority program is output to a channel used for connecting to a display device at a priority program transfer rate equal to a preceding program transfer rate used by a preceding program output immediately before the priority program.

47. The reception device of claim 46, wherein
the video stream further includes a 2D program encoded using a 2D encoding method, and
the decoding processor equalizes the priority program transfer rate and the preceding program transfer rate by performing, on one of the priority program and the preceding program, a conversion of decoded 2D images into 3D images by doubling data or a conversion of decoded 3D images to 2D images by halving data.

48. The reception device of claim 47, wherein
when the priority program is the 2D program and the preceding program is the 3D program,
the decoding processor generates 3D images without parallax by duplicating 2D images obtained upon decoding the priority program, and outputs 3D images obtained upon decoding the preceding program and the 3D images without parallax generated by duplication.

49. The reception device of claim 48, further comprising
an HDMI transmitter transmitting the 2D images and the 3D images obtained upon decoding to the display device, using a communication method conforming to a High-Definition Multimedia Interface (HDMI) standard, wherein
the reception device and the display device are connected via a channel conforming to the HDMI standard, and
when transmitting the 3D images without parallax, the HDMI transmitter adds a redundant flag indicating that the 3D images are without parallax.

50. The reception device of claim 47, wherein
when the priority program is the 2D program and the preceding program is the 3D program,
the decoding processor decodes the preceding program and selects one of left-view images and right-view images for output, and outputs 2D images obtained upon decoding the priority program.

51. The reception device of claim 50, wherein
the 3D program includes a left-view video stream and a right-view video stream, one of the left-view video stream and the right-view video stream being a base view video stream and the other being an additional view video stream, the additional view video stream having been generated with reference to the base view video stream,
the additional view video stream has additional information indicating whether or not the additional view video stream is usable when the reception device converts the 3D images into the 2D images, according to whether or not reduction has been applied to 3D source images to generate the additional view video stream, and
the decoding processor uses the additional information to specify which of the left-view images and the right-view images, obtained upon decoding the preceding program, is selected.

52. The reception device of claim 47, wherein
when the preceding program is the 2D program and the priority program is the 3D program,
the decoding processor outputs 2D images obtained upon decoding the preceding program, and decodes the priority program and selects one of left-view images and right-view images for output.

53. The reception device of claim 52, wherein
the 3D program includes a left-view video stream and a right-view video stream, one of the left-view video stream and the right-view video stream being a base view video stream and the other being an additional view video stream, the additional view video stream having been generated with reference to the base view video stream,
the additional view video stream has additional information indicating whether or not the additional view video stream is usable when the reception device converts the 3D images into the 2D images, according to whether or not reduction has been applied to 3D source images to generate the additional view video stream, and
the decoding processor uses the additional information to specify which of the left-view images and the right-view images, obtained upon decoding the priority program, is selected.

54. The reception device of claim 47, wherein
when the priority program is the 3D program and the preceding program is the 2D program,
the decoding processor generates 3D images without parallax by duplicating 2D images obtained upon decoding the preceding program, and outputs 3D images obtained upon decoding the priority program and the 3D images without parallax generated by duplication.

55. The reception device of claim 54, further comprising
an HDMI transmitter transmitting the 2D images and the 3D images obtained upon decoding to a display device, using a communication method conforming to an HDMI standard, wherein
the reception device and the display device are connected via a channel conforming to the HDMI standard, and
when transmitting the 3D images without parallax, the HDMI transmitter adds a redundant flag indicating that the 3D images are without parallax.

56. A reception device, comprising:
a stream receiver receiving a video stream made up of a plurality of programs, including a 2D program encoded using a 2D encoding method and a 3D program encoded using a 3D encoding method;
an information receiver receiving information for specifying a 3D program without parallax;
a decoding processor decoding the video stream received by the stream receiver; and
an HDMI transmitter transmitting 2D images and 3D images obtained upon decoding to a display device, using a communication method conforming to an HDMI standard, wherein
when transmitting 3D images without parallax, the HDMI transmitter adds a redundant flag indicating that the 3D images are without parallax.

57. The reception device of claim 56, wherein
the information receiver also receives information further specifying the priority program, among the programs in the video stream, as being intended for display on the display device connected to the reception device corresponding to a transmission device at a priority program display frequency equal to a preceding program display frequency used immediately previously, and
the HDMI transmitter performs control such that the redundant flag is added to the 3D images when the priority program includes the 3D images without parallax.

58. A reception device, comprising:
a stream receiver receiving a video stream encoded using a 3D encoding method;
a 3D decoder decoding the video stream; and
an output controller converting 3D images obtained upon decoding into 2D images for output, wherein
the video stream includes a left-view video stream and a right-view video stream, one of the left-view video stream and the right-view video stream being a base view video stream and the other being an additional view video stream, the additional view video stream having been generated with reference to the base view video stream,
the additional view video stream includes additional information indicating, in accordance with a reduction factor applied to 3D source images upon generation of the additional view video stream, whether the additional view video stream is usable when the reception device converts the 3D images into 2D images; and
the output controller uses the additional information to determine whether or not the additional view video stream is used when converting the 3D images into the 2D images.

59. A transmission method used by a transmission device, comprising:
encoding 3D images input thereto to generate a 3D program;
generating a video stream made up of a plurality of programs, including the 3D program generated by the 3D encoder;
transmitting the video stream; and
transmitting information for specifying a priority program among the programs in the video stream, the priority program being intended for output to a channel used for connecting a reception device corresponding to the transmission device to a display device at a priority program transfer rate equal to a preceding program transfer rate used for a preceding program output immediately before the priority program.

60. A computer program used by a transmission device, comprising:
encoding 3D images input thereto to generate a 3D program;
generating a video stream made up of a plurality of programs, including the 3D program generated by the 3D encoder;
transmitting the video stream; and
transmitting information for specifying a priority program among the programs in the video stream, the priority program being intended for output to a channel used for connecting a reception device corresponding to the transmission device to a display device at a priority program transfer rate equal to a preceding program transfer rate used for a preceding program output immediately before the priority program.

61. A reception method used by a reception device, comprising:
receiving a video stream made up of a plurality of programs, including a 3D program encoded using a 3D encoding method;
receiving information for specifying a priority program among the programs in the video stream; and
processing that includes decoding the video stream, using the information to specify the priority program, and performing control such that the priority program is output to a channel used for connecting to a display device at a priority program transfer rate equal to a preceding program transfer rate used by a preceding program output immediately before the priority program.

62. A computer program used by a reception device, comprising:
receiving a video stream made up of a plurality of programs, including a 3D program encoded using a 3D encoding method;
receiving information for specifying a priority program among the programs in the video stream; and
processing that includes decoding the video stream, using the information to specify the priority program, and performing control such that the priority program is output to a channel used for connecting to a display device at a priority program transfer rate equal to a preceding program transfer rate used by a preceding program output immediately before the priority program.
